(19) United States
(12) Patent Application Publication
(10) Pub. No.: US 2026/0147325 A1
(43) Pub. Date: May 28, 2026

(54) ACCESS CONTROL AND GOVERNANCE FOR AUTOMATIONS

(71) Applicant: UiPath, Inc., New York, NY (US)

(72) Inventors: Michael Aristo LEONARD, II, Alexandria, VA (US); Andrew HALL, Bellevue, WA (US)

(73) Assignee: UiPath, Inc., New York, NY (US)

(21) Appl. No.: 19/423,180

(22) Filed: Dec. 17, 2025

Related U.S. Application Data
(63) Continuation of application No. 19/420,178, filed on Dec. 15, 2025.
Application No. 19/420,178 is a continuation-in-part of application No. 18/350,800, filed on Jul. 12, 2023.
Application No. 18/350,800 is a continuation of application No. 16/924,499, filed on Jul. 9, 2020, now Pat. No. 11,733,668.

(51) Int. Cl. G05B 19/042; G06F 21/62

(52) U.S. Cl. CPC G05B 19/0426; G06F 21/6218; G05B 2219/39059

(57) ABSTRACT

Access control and governance for automations is disclosed. A code analyzer of an automation designer application, such as a workflow analyzer, may read access control and governance policy rules for an automation designer application and analyze activities of a workflow, tools, and/or prompts of the automation designer application against the access control and governance policy rules. When one or more analyzed activities of the workflow, one or more tools, and/or one or more prompts violate the access control and governance policy rules, the code analyzer prevents generation of an automation robot or publication of the automation until the workflow, the tools, and/or the prompts satisfy the access control and governance policy rules. When the analyzed activities of the workflow, the tools, and or the prompts comply with all required access control and governance policy rules, the automation designer application may generate an automation or publish the automation.

### CROSS-REFERENCE TO RELATED APPLICATIONS

This application is a continuation of, and claims the benefit of, U.S. Nonprovisional patent application Ser. No. 19/420,178 filed Dec. 15, 2025, which is a continuation-in-part (CIP) of, and claims the benefit of, U.S. Nonprovisional patent application Ser. No. 18/350,800 filed Jul. 12, 2023, which is a continuation of U.S. patent application Ser. No. 16/924,499 filed Jul. 9, 2020, and issued as U.S. Pat. No. 11,733,668 on Aug. 22, 2023. The subject matter of these earlier filed applications is incorporated by reference in its entirety.

### FIELD

The present invention generally relates to software automation, and more specifically, to robot access control and governance for automations.

### BACKGROUND

Certain actions taken by users of computing systems may violate laws or agreements in the U.S. and other countries, such as the E.U. General Data Protection Regulation (GDPR), the U.S. Health Insurance Portability and Accountability Act (HIPAA), third party terms of service, etc. Penalties for violation of these laws or agreements can be massive. For instance, with the GDPR, lower-level violations can merit a fine of €10 million or two percent of the violator's worldwide annual revenue (not profits), whichever is higher. A more serious violation can result in a fine of €20 million, or four percent of the violator's annual revenue, whichever is higher. These fines can be financially damaging to a company or even fatal. Automations, such as artificial intelligence (AI) agents and robotic process automation (RPA) robots, present a unique challenge to access control and governance. Accordingly, improved approaches to access control and governance for automations may be beneficial.

### SUMMARY

Certain embodiments of the present invention may provide solutions to the problems and needs in the art that have not yet been fully identified, appreciated, or solved by current software automation technologies. For example, some embodiments of the present invention pertain to robot access control and governance for automations.

In an embodiment, one or more computer programs for performing access control and governance for automations are embodied on one or more non-transitory computer-readable media. The one or more computer programs are configured to cause at least one processor to analyze at least one of activities of a workflow, one or more tools, and one or more prompts of the RPA designer application against the access control and governance policy rules by running a series of rules that inspect the activities of the RPA workflow, the one or more tools, and/or the one or more prompts. Responsive to one or more analyzed activities of the workflow, at least one of the one or more tools, and/or at least one of the one or more prompts violating the access control and governance policy rules, the one or more computer programs are configured to cause the at least one processor to prevent generation of an automation or publication of the automation until the automation satisfies the access control and governance policy rules. Responsive to the analyzed activities of the workflow, the one or more tools, and/or the one or more prompts complying with all required access control and governance policy rules, the one or more computer programs are configured to cause the at least one processor to generate an automation or publish the automation.

In another embodiment, a computer-implemented method for performing access control and governance for automations includes analyzing at least one of activities of a workflow, one or more tools, and one or more prompts of an automation by an automation designer application against access control and governance policy rules, by a code analyzer of a computing system. Responsive to one or more analyzed activities of the workflow, at least one of the one or more tools, and/or at least one of the one or more prompts violating the access control and governance policy rules, the computer-implemented method includes preventing generation of an automation or publication of the automation until the automation satisfies the access control and governance policy rules, by the code analyzer of the computing system. The code analyzer is computer code that automatically runs the access control and governance policy rules as a series of rules that inspect the code written by a user.

In yet another embodiment, one or more computing systems include memory storing computer program instructions for performing access control and governance for automations and at least one processor configured to execute the computer program instructions. The computer program instructions are configured to cause the at least one processor to analyze at least one of activities of a workflow, one or more tools, and one or more prompts for an automation by an automation designer application against access control and governance policy rules by running a series of rules that inspect the activities of the workflow, the one or more tools, and/or the one or more prompts. Responsive to one or more analyzed activities of the workflow, at least one of the one or more tools, and/or at least one of the one or more prompts violating the access control and governance policy rules, the computer program instructions are configured to cause the at least one processor to prevent generation of an automation or publication of the automation until the automation satisfies the access control and governance policy rules. Responsive to the analyzed activities of the workflow, the one or more tools, and/or the one or more prompts complying with all required access control and governance policy rules, the computer program instructions are configured to cause the at least one processor to generate an automation or publish the automation. The access control and governance policy rules include one or more application and/or universal resource locator (URL) restrictions, one or more package restrictions, one or more activity restrictions, one or more activity property requirements, or a combination thereof. The access control and governance policy rules are defined for the automation designer application based on an organization, a role, a group, an individual developer, or a combination thereof.

In still another embodiment, a computer-implemented method for performing runtime access control and governance for automations includes checking at least one of one or more actions to be performed by an automation, information requested by the automation, one or more tools used by the automation, and one or more prompts for the automation against access control and governance rules. The computer-implemented method also includes, responsive to the automation, based on the access control and governance rules, being permitted to perform the one or more actions, receive the requested information, use the one or more tools, and/or use the one or more prompts, authorizing the one or more actions, providing the automation with the requested information, authorizing use of the one or more tools, and/or authorizing use of the one or more prompts. The computer-implemented method further includes, responsive to the automation, based on the access control and governance rules, not being permitted to perform the one or more actions, receive the requested information, use the one or more tools, and/or use the one or more prompts, preventing the automation from taking the one or more actions, obtaining the requested information, using the one or more tools, and/or using the one or more prompts.

In another embodiment, one or more computer programs for performing access control and governance for automations are embodied on one or more non-transitory computer-readable media. The one or more computer programs are configured to cause at least one processor to check at least one of one or more actions to be performed by an automation, information requested by the automation, one or more tools used by the automation, and one or more prompts used by the automation against access control and governance rules. The one or more computer programs are also configured to cause the at least one processor to, responsive to the automation, based on the access control and governance rules, not being permitted to perform the one or more actions, receive the requested information, use the one or more tools, and/or use the one or more prompts, prevent the automation from taking the one or more actions, obtaining the requested information, using the one or more tools, and/or using the one or more prompts.

In yet another embodiment, one or more computing systems include memory storing computer program instructions and at least one processor configured to execute the computer program instructions. The computer program instructions are configured to cause the at least one processor to check at least one of one or more actions to be performed by an automation, information requested by the automation, one or more tools used by the automation, and one or more prompts used by the automation against access control and governance rules. The computer program instructions are also configured to cause the at least one processor to, responsive to the automation, based on the access control and governance rules, not being permitted to perform the one or more actions, receive the requested information, use the one or more tools, and/or use the one or more prompts, prevent the automation robot from taking the one or more actions, obtaining the requested information, using the one or more tools, and/or using the one or more prompts, and send a notification to the automation or a client-side application indicating that the one or more actions, the access to the information, the use of the one or more tools, and/or the use of the one or more prompts is not permitted, automatically end execution of the automation, or both.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is an architectural diagram illustrating a hyper-automation system configured to perform agentic automation and orchestration, according to an embodiment of the present invention.

FIG. 2 illustrates some of the combined capabilities of an AI agent and an RPA robot, according to an embodiment of the present invention.

FIG. 3 illustrates pools of AI agents, robotic process automation (RPA) robots, agentic orchestration processes (AOPs), and applications, according to an embodiment of the present invention.

FIGS. 4A and 4B illustrate an example AI agent service interface, according to an embodiment of the present invention.

FIG. 5 illustrates an example AOP development interface, according to an embodiment of the present invention.

FIG. 6 illustrates an example RPA development interface, according to an embodiment of the present invention.

FIG. 7 illustrates an end-to-end AI agent, RPA robot, and AOP development and deployment system, according to an embodiment of the present invention.

FIG. 8 is an architectural diagram illustrating an agentic automation and RPA system, according to an embodiment of the present invention.

FIG. 9 is an architectural diagram illustrating a deployed RPA system, according to an embodiment of the present invention.

FIG. 10 is an architectural diagram illustrating the relationship between a designer, activities, and drivers, according to an embodiment of the present invention.

FIG. 11 is an architectural diagram illustrating a computing system configured to perform robot access control and governance for automations, according to an embodiment of the present invention.

FIG. 12A illustrates an example of a neural network that has been trained to assist with performing robot access control and governance for automations, according to an embodiment of the present invention.

FIG. 12B illustrates an example of a neuron, according to an embodiment of the present invention.

FIG. 13 is an architectural diagram illustrating a reference architecture for a generative AI model, according to an embodiment of the present invention.

FIG. 14 is a flowchart illustrating a process for training AI/ML model(s), according to an embodiment of the present invention.

FIG. 15 is a screenshot illustrating a view of a folder of the Windows® Registry Editor for UiPath Studio™, according to an embodiment of the present invention.

FIG. 16 is a screenshot illustrating a portion of a Windows Explorer® UI in which the file SampleGovernanceRules.dll is installed in the Rules folder for UiPath Studio™, according to an embodiment of the present invention.

FIG. 17 is a screenshot illustrating a package management interface, according to an embodiment of the present invention.

FIG. 18 is screenshot illustrating an upper right portion of an automation designer application with the send feedback icon disabled, according to an embodiment of the present invention.

FIGS. 19A-D are screenshots illustrating a workflow analyzer settings interface, according to an embodiment of the present invention.

FIG. 20 is a screenshot illustrating an automation designer application settings interface, according to an embodiment of the present invention.

FIGS. 21A and 21B are screenshots illustrating an RPA workflow, according to an embodiment of the present invention.

FIG. 22 illustrates an error list interface, according to an embodiment of the present invention.

FIG. 23 is a screenshot illustrating a workflow analyzer interface, according to an embodiment of the present invention.

FIG. 24 is an architectural diagram illustrating a system for performing access control and governance for automations during execution, according to an embodiment of the present invention.

FIG. 25 is a flowchart illustrating a process for performing access control and governance for an automation designer application, according to an embodiment of the present invention.

FIG. 26 is a flowchart illustrating a process for performing access control and governance for an executing automation, according to an embodiment of the present invention.

Unless otherwise indicated, similar reference characters denote corresponding features consistently throughout the attached drawings.

### DETAILED DESCRIPTION OF THE EMBODIMENTS

Some embodiments pertain to robot access control and governance for automations. Automation governance is the ability for organizations to put policies in place to prevent users from developing automations capable of taking actions that may harm the organization, such as violating GDPR, HIPAA, third party application terms of service, etc. Since developers may create automations that violate privacy laws, terms of service, etc. while performing their operations, some embodiments implement access control and governance restrictions at the automation and/or automation design application level. This may provide an added level of security and compliance into to the automation process development pipeline in some embodiments by preventing automation developers from taking dependencies on unapproved software libraries that may either introduce security risks or work in a way that violates policies, regulations, privacy laws, and/or privacy policies.

Some embodiments prevent automations from taking actions that are allowed by the user but not by software alone (e.g., via a workflow, tools used by the automation, and/or prompts for the automation). Traditionally, organizations can control what a user may and may not do through access control to their systems. However, in the context of automations, and especially attended automation, this control may break down. The automation performs tasks on behalf of the user, which means that the backend system is unable to distinguish that a software automation is accessing the system versus a user.

This can be problematic for several reasons. For example, backend systems may allow the user to access certain data that could be misused. However, good system design typically makes it difficult for the user to cause issues at any scale because doing something they should not is slow and tedious. By contrast, if an automation is used, the automation can greatly increase the scale of the data misuse or policy violation due to its speed of execution.

Consider the following examples. An organization uses a customer relationship management (CRM) system for contacting customers that fully supports various privacy options, such the “opt out” and “forget me” policies of GDPR and other user protection laws by checking whether a user has chosen the “do not contact me” option and providing links to privacy policies and instructions for requesting for an organization to “forget them”. The organization has chosen to give a broad portion of employees access to the CRM system, but to only give a select few employees permissions to send emails in the system.

However, legitimate business purposes require that this broader set of users have access to customer profiles, which include their email address (e.g., the employee may create or edit misinformation including the customer's email address in the system when working with a customer). It is an organizational policy violation to email a customer not using the CRM system, but some employees are looking to learn some information and do not want to wait for the various approval channels to gain those permissions or have an appropriately permissioned employee do so on their behalf. Without an automation, the employees can still violate this policy, but because it is tedious to manually copy and paste email addresses one-by-one out of the system. Even if employees violate this policy, the scale of the violation will be small, and therefore, mitigate the risk to the organization if any violation happens. However, an automation can extract this data many orders of magnitude faster than a human (e.g., thousands of times faster, tens of thousands of times faster, hundreds of thousands of times faster, millions of times faster, etc.) to create and send the emails, so where a user may manually send 5-10 emails violating the policy and open the company up to risk of violating a GDPR “opt out” by the customer, if the user creates an automation to this, they could send a large number of violating emails.

As another example, consider a healthcare organization that uses carefully protected systems to store all data in a HIPAA compliant manner. Employees may legitimately access and work with this data in the context of the appropriate application(s). An employee who is frustrated with the inefficiency of the system may want to write an automation that extracts patient data into an unprotected Excel® spreadsheet on his or her desktop. This is now a HIPAA violation, and if something were to happen to that data, such as the employee's computer being stolen and accessed, this could open the organization up to significant financial and legal liability.

As yet another example, consider the case where the terms of service for a third party application or service prohibit using automation to work with the application or service. If an employee chooses to write an automation that works against these terms of service, the company could be legally liable.

These problems and others may present substantial risks to organizations employing automations. However, some embodiments reduce or eliminate security and compliance risks from developers by preventing developers from using unapproved library and activity references. An automation developer, whether a trained developer (e.g., using UiPath Studio™) or an untrained citizen developer (e.g., using UiPath StudioX™) may add references to libraries that are either considered unsafe or work in a manner that violates policy/regulatory rules.

Consider the following examples. The United States government does not allow the use of technology developed in Russia or other countries considered to be unfriendly to be installed on U.S. government computing systems. There are, however, some common libraries used in automations, such as RPA, that have been developed by Russian companies (e.g. the Abbyy® OCR engine). While developers can choose not to have these libraries available by default on their computing systems, they cannot explicitly prevent a user from taking a dependency incorporating these libraries in an automation project. While Internet access for automation developers may be blocked, which is not desirable for many reasons when developing software, a developer could still bring the unapproved libraries to the computing system via another mechanism, such as a universal serial bus (USB) stick.

As another example, many financial institutions have strict policies in place regarding what information may and may not leave their internal networks and firewalls. In the modern era, many automation libraries (e.g., those called via RPA activities) work by communicating with servers on public clouds, such as UiPath® document understanding activities. These financial institutions are concerned that users will not realize that using these activities is not allowed because they may send sensitive data outside the company firewall. However, there are no previously existing effective options to prevent this from happening.

Still another concern is preventing automation at scale from overwhelming systems. One of the reasons for the massive success of RPA, for example, is that it enables automation of legacy systems without requiring upgrades to those systems. Because legacy systems were not designed to be automated, their design and performance may only be capable of handling interactions at the speed at which humans can work. However, legacy applications are not always able to keep up with the speed at which an automation may interact with the system. An automation that is not designed to operate within these constraints may essentially end up overwhelming legacy systems with faster requests than they can process, essentially performing an accidental denial of service (DoS) attack on the system. While settings exist in UiPath Studio™, that enable delays between activities, there is no currently existing central enforcement mechanism to ensure that developers use these settings when working with legacy systems that are not capable of operating at automation speeds.

Yet another concern is ensuring organizational policy compliance. Many organizations have specific rules that they want to apply to automations. For instance, some examples include enforcing that emails created by automation are only sent to internal employees and not external recipients, enforcing that all emails created by automation are saved as a draft and not sent without human review, etc. Without appropriate governance, these policies may be violated by automations.

To address various problems access control and governance problems that may occur in automations, some embodiments provide the ability for organizations to define and enforce governance policies. For example, this may be implemented via a JavaScript Object Notation (JSON) file that defines what an automation can and/or cannot access. In some embodiments, organizations may place controls on what applications and/or universal resource locators (URLs) may and/or may not be automated, place controls on what activities may and/or may not be used, place controls on what packages (e.g., libraries) may and/or may not be used, provide the ability to create and deploy custom rules that expand the governance capabilities, provide various automation designer application settings that may control, for example, which package feeds users may use to install libraries from, etc.

In some embodiments, governance may be enforced at design time (i.e., when the developer is building, testing, and revising the automation workflow). However, this may make it difficult or impossible to enforce certain policies. For instance, it may be difficult or impossible to enforce policies where the value that the policy is being applied to is only known at runtime. If an organization desires to put a policy in place preventing the access to certain websites, for instance, the design time analysis should be able to know the URL to flag. However, it is possible to construct the automation program in such a way in some embodiments that the value is loaded from a dynamic source, such as an external file or a prompt asking the user. In this case, design time analysis is not sufficient since the value that violates the policy is not known at design time. Another example is if an organization desires to prevent automating email to customers outside the organization, but the list of email addresses comes from a spreadsheet. In this case, the emails are not known at design time, but are instead a dynamic input to the system that should be evaluated at runtime.

In certain embodiments, governance is enforced at runtime in addition to or in lieu of design time enforcement. This may be accomplished via a server-side application for configuring and deploying policies, for example. Policies may be automatically sent to user computing systems when these computing systems connect to a server-side conductor application, for example. The automation designer application may automatically insert code into the automations that forces them to obtain these policies and operate in compliance therewith.

In some embodiments, controls may be defined for an automation designer application based on the organization, role, group, the individual developer, etc. to control what developers may do when developing automations. Policies may be defined and controls may be enforced to control what an automation may do when running an automation. Such embodiments may enable organizations to better meet their compliance and governance requirements with respect to laws, regulations, agreements, and company policies.

In some embodiments, local files can only be modified by administrator. As such, non-administrator users should not be able to override or change these files. Package feeds may be locked down such that only desired feeds are available and additional feeds cannot be added. This prevents users from using packages that are obtained elsewhere. In certain embodiments, a “send feedback” tool may be disabled as part of the policy.

A “package feed”, as used herein, is a location (either remote or local) that contains access to additional libraries that the developer may optionally choose to install to gain additional capabilities for his or her automation project. A library, as used herein, is a package containing computer code that provides additional capabilities (e.g., activities) to a project. An example of a package feed is the UiPath Connect™ marketplace. This is an open location where community members may upload libraries including custom activities that they have written. If a UiPath® developer wishes to use these capabilities, that developer can browse and add library references to his or her projects. An example of a library is the UiPath GSuite™ activities. The default installation of UiPath Studio™ does not give developers the ability to work with GSuite™. However, developers may install the GSuite™ activity library that now gives that project the ability to use activities for working with Gsuite™ (e.g., Gmail®, Google Sheets, Google Drive, etc.).

In some embodiments, a code analyzer, such as a program analyzer or a workflow analyzer, is provided as an audit function for the designer application. The workflow analyzer may define what is permitted for users when they run the designer application and may enforce policies. For instance, permitted URLs may be specified that a user may work with, certain URLs may be restricted, etc.

As used herein, a “code analyzer” is computer code that runs a series of rules that inspect the code written by the user and produce feedback (e.g., messages, warnings, errors, etc.) when the application does not satisfy the rules. In some embodiments, the code analyzer is provided by the vendor of the designer application (e.g., UiPath®) or written by customers using the designer application. An example of a code analyzer rule is the “App/Url Restrictions” rule in UiPath Studio™ that allows organizations to define what desktop applications and website URLs may or may not be used in an automation project. If the user breaks one of these rules, he or she will receive a notification at the severity specified in the governance policy. In some embodiments, this is usually an error that will prevent the automation from being published or run.

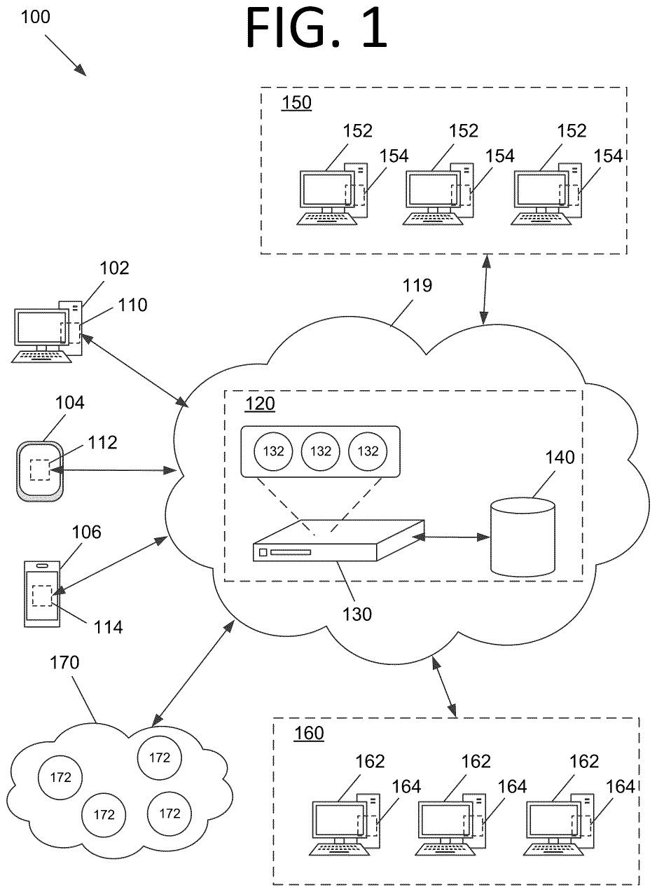

FIG. 1 is an architectural diagram illustrating a hyper-automation system 100 configured to perform agentic automation and orchestration, according to an embodiment of the present invention. “Hyper-automation,” as used herein, refers to automation systems that bring together components of process automation, integration tools, and technologies that amplify the ability to automate work. Some examples of these components include, but are not limited to, AI agents, agentic orchestration processes (AOPs), and robotic process automation (RPA) robots.

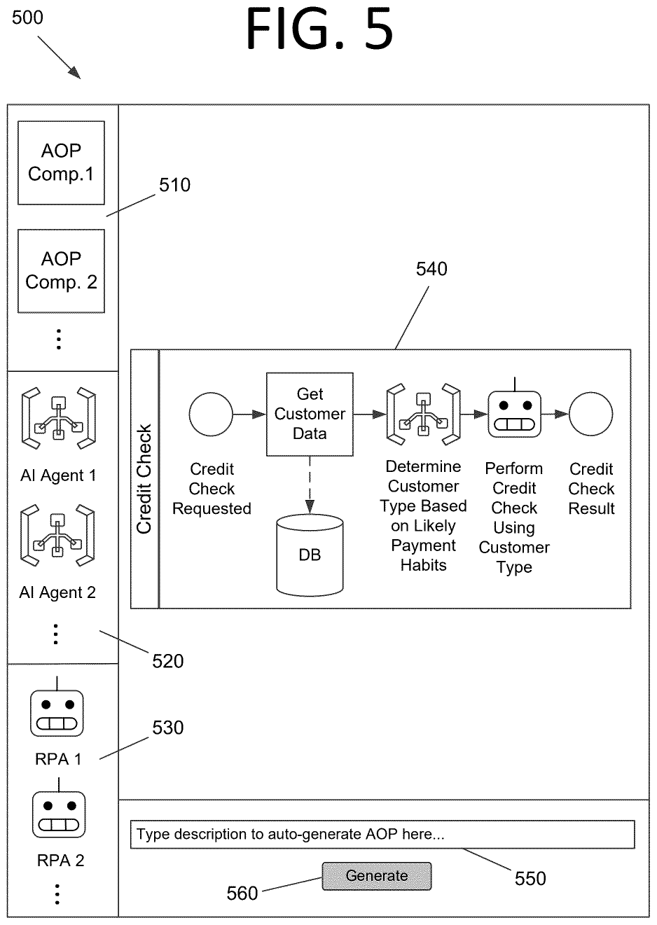

Generally, as used herein, “AI agents” are AI-enhanced, probabilistic automations that act independently, act dynamically, make decisions, execute actions, and act adaptively. This may be due to the use of large language models (LLMs) by the AI agents. AI models are typically probabilistic in nature themselves. “AOPs” are automations that allow users to describe overall business processes. AOPs may be created using an interface that allows the creation of business flowcharts that are described in Business Process Model and Notation (BPMN), which is an Extensible Markup Language (XML) description of the business process. See FIG. 5, for example. “RPA robots” are rules-based, deterministic automations that act predictably and make deterministic decisions.

For instance, RPA may be used at the core of a hyper-automation system in some embodiments, and in certain embodiments, automation capabilities may be expanded with AI/machine learning (ML), process mining, analytics, and/or other advanced tools. As the hyper-automation system learns processes, trains AI/ML models, and employs analytics, for example, more and more knowledge work may be automated, and computing systems in an organization, e.g., both those used by individuals and those that run autonomously, may all be engaged to be participants in the hyper-automation process. Hyper-automation systems of some embodiments allow users and organizations to efficiently and effectively discover, understand, and scale automations.

In such embodiments, AI agents “coexist” in tandem with RPA robots that execute RPAs and AOPs. As noted herein, AI agents are automations, enhanced with AI skills, that can act independently and dynamically make decisions, execute actions, and adapt their performance. The AI agents can dynamically leverage the tools available via these RPA robots to perform document processing (see, for example, U.S. Patent Application Publication No. 2021/0097274), user interface (UI) automation (see, for example, U.S. Pat. Nos. 10,654,166, 10,990,876, 11,080,548, 11,507,259, 11,733,668, and 11,748,069), semantic copy-and-paste between a source and a target (see, for example, U.S. Pat. No. 12,124,806 and U.S. Patent Application Publication Nos. 2023/0107316, 2023/0415338, and 2024/0220581), etc. AI agents can dynamically select these tools and execute them in the form of a pipeline.

Generally speaking, agentic automation is a probabilistic automation performed by one or more AI agents. Agentic automation expands the automation potential of organizations by placing focus not just on individual tasks, but on entire end-to-end processes. Teams of RPA robots, directed by AI agents, may enable a single employee to achieve the work of many. Agentic automation, via AI agents, gives managers the space to mentor, doctors more time to care for patients, developers the ability to fine-tune their work, engineers the freedom to innovate, and customers seamless and personalized experiences.

Various technical effects, benefits, and advantages may be achieved via agentic automation in some embodiments. Agentic automation improves memory usage by requiring less storage for data and increases processor efficiency by reducing the number of calls and actions. Agentic automation also potentially provides the ability to process gigabytes, terabytes, petabytes, or more, of data that would not be possible by human-implemented processes, whether mental or by hand. Agentic automation also potentially enables fewer triggers and models to be used via dynamic decision making. Whereas RPA alone may require 100 actions in an example scenario, using agentic automation, this may be reduced substantially (e.g., to 15 actions). Context grounding may also be employed to tether the AI agent to the desired context for the agentic automation. Accordingly, context grounding “constrains” an LLM to a pertinent context.

AI agents may have agentic memory that evolves and remembers user interactions, feedback, corrections, and solutions (e.g., dynamic user inputs from human-in-the-loop operations). As used herein, “human-in-the-loop” or human-in-the-loop operations can include AI agents and RPA robots working cooperatively with users to receive dynamic direct user inputs. In some embodiments, rather than being trained before being introduced into the production environment, the AI agent(s) are initially 100% reliant on human-in-the-loop. As the agentic memory processes human responses and grows, the AI agent can become increasingly autonomous, reducing the need for dynamic direct human inputs and improving efficiency. This may be accomplished via Retrieval Augmented Generation (RAG) or model fine-tuning (e.g., using supervised fine-tuning (SFT) or Low Rank Adaptation (LoRA)). As such, as the AI agent learns to address more and more scenarios, the AI agent will seek to autonomously and dynamically select and implement solutions using the multiple tools at its disposal. AI agents may also learn to be more efficient based on the agentic memory if more efficient solutions are contained therein or derived therefrom. For instance, AI agents may periodically process the agentic memory to analyze patterns to achieve greater autonomy. Agentic automation gives AI agents the power to plan, work, and make decisions with minimal human oversight once sufficiently trained.

As used herein, “agentic memory” is a dynamic caching (i.e., storing) system for managing escalations and tool calls. By way of example operation, when the AI agent encounters a problem while running, the AI agent can prompt or otherwise request from a user interaction(s) or feedback about overcoming the problem, store/cache the interaction(s) or feedback, and learn from this interaction or feedback to reduce the need for repeated human input. According to one or more technical effects, benefits, and advantages, agentic memory provides enhanced efficiency by storing solutions to common problems and minimizing potentially costly tool calls. The cooperative operations of the AI agents and the agentic memory potentially “bend the curve” so human interaction is required less and less as the AI agent continually learns via the agentic memory.

Generally speaking, agentic orchestration is implemented by a conductor application to implement one or more AOPs that make use of AI agents and RPA robots. Agentic orchestration in some embodiments orchestrates AI agents (e.g., UiPath Agents™), third-party agents, RPA robots (e.g., UiPath Robots™), AOPs, and humans executing an agentic workflow (e.g., if human approval is required). Agentic orchestration thus enables the automation, modeling, and monitoring of complex business processes from start to finish. Agentic orchestration also provides the unique ability to orchestrate RPA robots, AI agents, third party agents, and people across end-to-end agentic workflows. Agentic orchestration is beneficial for the successful scaling of agentic automation.

AI agents for agentic automation are AI model-based, per the above, enabling the AI agents to work independently of people and implement these agentic automations. AI agents are also goal-oriented, using context to make probabilistic decisions. Further, AI agents are well-suited for ad hoc tasks that require high adaptability. AI agents learn how work is done and improve over time. AI agents can use and choose various tools for accomplishing tasks, gathering context, and taking actions (often through RPA robots used by the AI agents as tools). In some embodiments, AI agents can build workflows and generate automations for RPA robots and/or other AI agents to execute, such as by leveraging UiPath Autopilot™ for developers or another application that helps developers expedite the creation and testing of automations. For instance, AI agents may utilize the designer application via an API to generate another AI agent or an RPA workflow, followed by a human-in-the-loop operation to address any issues with the generated workflow. If correct, the workflow may then be deployed. AI agents may also have varying degrees of autonomy, which is governed by the agentic orchestration.

The AI agent, by executing an “agentic loop,” generates a dynamic plan to achieve goals per instructions using the provided tools and context. Once the dynamic plan is generated, the AI agent utilizes an efficient execution path for the dynamic plan. If the dynamic plan has two or more steps that can be executed in parallel, the AI agent executes these steps in parallel based on the available resources. After each step is completed, the AI agent retrieves the output from the step and regenerates the next step or steps. Thus, the agentic loop continues until the goals are achieved. Executing the steps of the dynamic plan in parallel and using the ecosystem tools and context grounding are advanced capabilities for the agentic orchestration.

AI agents can also re-plan after each step in some embodiments. In other words, the initial plan is a suggestion. The AI agent may also be able to trace back in advanced scenarios and figure out that it is on the wrong path (e.g., by pre-planning potential paths using a tree of thoughts approach).

As noted herein, RPA robots are rules-based, act predictably, and make deterministic decisions. RPA robots are highly reliable, efficient, and well-suited for routine tasks. RPA robots, along with AI agents, may use human-in-the-loop operations for exception management. According to some embodiments, AI agents are more flexible, more abstract, and more self-determining than RPA robots and AOPs. RPA robots are typically more stable, more concrete, and more governable than AI agents and AOPs. AOPs processes typically fall in between the respective flexibility/stability, abstract/concrete, and self-determining/governable qualities of AI agents and RPA robots.

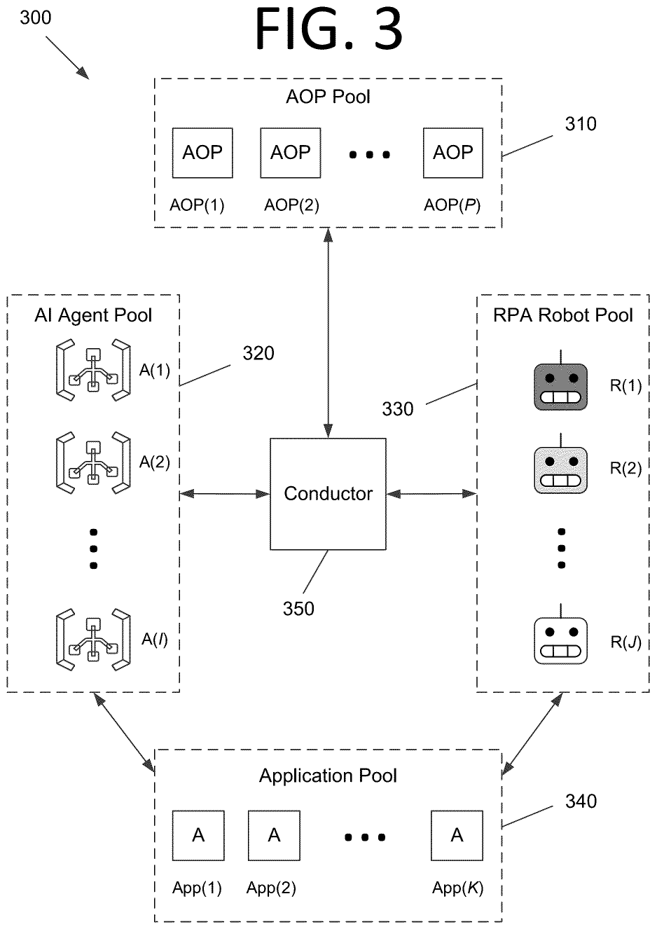

As described further herein with respect to FIG. 3, AI agents and RPA robots can potentially find and use one another as tools to accomplish a task. AI agents and RPA robots may also be able to access and use various applications (e.g., via APIs). Tools may be manually configured for an automation by a developer and/or the AI agents and RPA robots may discover and use tools at runtime.

According to some embodiments, AI agents, AOPs, and RPA robots may work cooperatively with users (e.g., human-in-the-loop), enabling AI agents, AOPs, and RPA robots to make faster, more consistent, and more informed decisions. Furthermore, the use of AI agents, AOPs, and RPA robots enables people to accomplish more, as AI agents, AOPs, and RPA robots may take on additional repetitive, mundane, and ad hoc tasks at a scale that is not possible for human users to operate. People may make the necessary decisions when AI agents, AOPs, or RPA robots encounter an exception. People may thus be elevated to, and focused on, being supervisors, decision makers, and organizational leaders.

AI models provide AI agents with the ability to reason, plan, create, and make autonomous decisions. AI models can also be used by RPA robots for task-specific activities, such as processing a document or analyzing data. AI models may be enhanced with business-specific content and context (e.g., from a collection of context repositories for an enterprise), improving the accuracy and results of the AI models. AI models can be applied individually or concurrently, depending on the complexity of the task. AI model selection can come from the RPA vendor's model library, third-party models, and bring-your-own-model (BYOM) options (see, for example, U.S. Pat. Nos. 11,738,453 and 11,748,479).

Hyper-automation system 100 includes user computing systems, such as desktop computer 102, tablet 104, and smart phone 106. However, any desired user computing system may be used without deviating from the scope of the invention including, but not limited to, smart watches, laptop computers, servers, Internet-of-Things (IoT) devices, etc. Also, while three user computing systems are shown in FIG. 1, any suitable number of user computing systems may be used without deviating from the scope of the invention. For instance, in some embodiments, dozens, hundreds, thousands, or millions of user computing systems may be used. The user computing systems may be actively used by a user or run automatically without much or any user input.

As disclosed herein, there are three types of automations in some embodiments: (1) agentic automations that are implemented by respective AI agents; (2) RPAs that are implemented by respective RPA robots; and (3) composite automations that are achieved by a combination of AI agent(s) and RPA robot(s) to accomplish a more complex overall task. Automations 110, 112, 114 may include, but are not limited to, those executed by RPA robots and/or AI agents, whether individually or to achieve a larger composite automation. Other processes may also be implemented, such as listeners. These processes may be standalone applications, subprocesses of another application, part of an operating system, any other suitable software and/or hardware, or any combination of these without deviating from the scope of the invention. Indeed, in some embodiments, the logic of the process(es) is implemented partially or completely via physical hardware.

Each user computing system 102, 104, 106 has respective automations 110, 112, 114 running thereon. In some embodiments, automations 110, 112, 114 can be stored remotely (e.g., on server 130 or in database 140 and accessed via network 119) and loaded by RPA robots and/or AI agents to implement automations 110, 112, 114. RPA automations may exist as a script (e.g., Extensible Markup Language (XML), Extensible Application Markup Language (XAML), etc.) or be compiled into machine readable code (e.g., as a digital link library). In the case of AI agents, agentic automations may be generated based on plain text descriptions of a desired goal, for example.

Listeners monitor and record data pertaining to user interactions with respective computing systems and/or operations of unattended computing systems and send the data to a core hyper-automation system 120 including a server 130 and accessed via network 119 (e.g., a local area network (LAN), a mobile communications network, a satellite communications network, the Internet, any combination thereof, etc.). The data may include, but is not limited to, which buttons were clicked, where a mouse was moved, the text that was entered in a field, that one window was minimized and another was opened, the application associated with a window, etc. In certain embodiments, the data from the listeners may be sent periodically as part of a heartbeat message. In some embodiments, the data may be sent to core hyper-automation system 120 once a predetermined amount of data has been collected, after a predetermined time period has elapsed, or both. One or more servers, such as server 130, receive and store data from the listeners in a database, such as database 140.

In the case of automations 110, 112, 114 being RPAs, automations may execute the logic developed in workflows during design time. The workflows may include a set of steps, defined herein as “activities,” that are executed in a sequence or some other logical flow. Each activity may include an action, such as clicking a button, reading a file, writing to a log panel, etc. In some embodiments, workflows may be nested or embedded.

Long-running workflows for RPA in some embodiments are master projects that support service orchestration, human-in-the-loop, and long-running transactions in unattended environments. See, for example, U.S. Pat. No. 10,860,905, which is hereby incorporated by reference in its entirety. Human-in-the-loop comes into play when certain processes require human inputs (e.g., dynamic direct user inputs) to handle exceptions, approvals, or validation before proceeding to the next step in the activity. In this situation, the process execution is suspended, freeing up the RPA robots until the human-in-the-loop portion of the task is completed.

A long-running workflow may support workflow fragmentation via persistence activities and may be combined with invoke process and non-user interaction activities, orchestrating human tasks with RPA robot tasks. In some embodiments, multiple or many computing systems may participate in executing the logic of a long-running workflow. The long-running workflow may run in a session to facilitate speedy execution. In some embodiments, long-running workflows may orchestrate background processes that may contain activities performing API calls and running in the long-running workflow session. These activities may be invoked by an invoke process activity in some embodiments. A process with user interaction activities that runs in a user session may be called by starting a job from a conductor activity (conductor described in more detail later herein). The user may interact through tasks that require forms to be completed in the conductor in some embodiments. Activities may be included that cause the RPA robot to wait for a form task to be completed and then resume the long-running workflow.

One or more of automations 110, 112, 114 is in communication with core hyper-automation system 120. In some embodiments, core hyper-automation system 120 may run a conductor application on one or more servers, such as server 130. While one server 130 is shown for illustration purposes, multiple or many servers that are proximate to one another or in a distributed architecture may be employed without deviating from the scope of the invention. For instance, one or more servers may be provided for conductor functionality, AI/ML model serving, authentication, governance, and/or any other suitable functionality without deviating from the scope of the invention. In some embodiments, core hyper-automation system 120 may incorporate or be part of a public cloud architecture, a private cloud architecture, a hybrid cloud architecture, etc. In certain embodiments, core hyper-automation system 120 may host multiple software-based servers on one or more computing systems, such as server 130. In some embodiments, one or more servers of core hyper-automation system 120, such as server 130, may be implemented via one or more virtual machines (VMs).

In some embodiments, one or more of automations 110, 112, 114 may call one or more AI/ML models 132 deployed on or accessible by core hyper-automation system 120 and trained to accomplish various tasks. For instance, AI/ML models 132 may include models trained to look for various application versions, perform computer vision (CV), perform optical character recognition (OCR), generate UI descriptors, offer suggestions for next activities or sequences of activities in RPA workflows, perform semantic matching, perform natural language processing (NLP), generate or modify code and/or RPA workflows, etc. AI/ML models may be trained using labeled data that includes, but is not limited to, elements from data sources (e.g., web pages, forms, scanned documents, application interfaces, screens, etc.), previously created RPA workflows, screenshots of various application screens for various versions with their corresponding UI elements, libraries of UI objects, etc. AI/ML models 132 may be trained to achieve a desired confidence threshold while not being overfit to a given set of training data. Generally speaking, UI elements, UI descriptors, applications, and application screens can be considered to be UI objects.

AI/ML models 132 may be trained for any suitable purpose without deviating from the scope of the invention, as will be discussed in more detail later herein. Two or more of AI/ML models 132 may be chained in some embodiments (e.g., in series, in parallel, or a combination thereof) such that they collectively provide collaborative output(s). AI/ML models 132 may perform or assist with CV, OCR, document processing and/or understanding, semantic learning and/or analysis, analytical predictions, process discovery, task mining, testing, automatic RPA workflow generation, sequence extraction, clustering detection, audio-to-text translation, NLP, semantic matching, any combination thereof, etc. However, any desired number and/or type(s) of AI/ML models may be used without deviating from the scope of the invention.

Using multiple AI/ML models may allow the system to develop a global picture of what is happening on a given computing system, for example. For instance, one AI/ML model could perform OCR, another could detect buttons, another could compare sequences, etc. Patterns may be determined individually by an AI/ML model or collectively by multiple AI/ML models. In certain embodiments, one or more AI/ML models are deployed locally on at least one of computing systems 102, 104, 106.

In some embodiments, multiple AI/ML models 132 may be used. Each AI/ML model 132 is an algorithm (or model) that runs on the data, and the AI/ML model itself may be a deep learning neural network (DLNN) of trained artificial “neurons” that are trained on training data, for example. In some embodiments, AI/ML models 132 may have multiple layers that perform various functions, such as statistical modeling (e.g., hidden Markov models (HMMs)), and utilize deep learning techniques (e.g., long short term memory (LSTM) deep learning, encoding of previous hidden states, etc.) to perform the desired functionality.

Hyper-automation system 100 may provide four main groups of functionality in some embodiments: (1) discovery; (2) building automations; (3) management; and (4) engagement. Automations (e.g., run on a user computing system, a server, etc.) may be run by RPA robots, AOPs, or AI agents, for example, in some embodiments, and may provide any of the functionality described herein. By way of example, RPA robots can include attended robots, unattended robots, and/or test robots. Attended robots work with users to assist them with tasks (e.g., via UiPath Assistant™). Unattended robots work independently of users and may run in the background, potentially without user knowledge. Test robots are unattended robots that run test cases against applications or RPA workflows. Test robots may be run on multiple computing systems in parallel in some embodiments.

The discovery functionality may discover and provide automatic recommendations for different opportunities of automations of business processes. Such functionality may be implemented by one or more servers, such as server 130. The discovery functionality may include providing an automation hub, process mining, task mining, and/or task capture in some embodiments. The automation hub (e.g., UiPath Automation Hub™) may provide a mechanism for managing automation rollout with visibility and control. Automation ideas may be crowdsourced from employees via a submission form, for example. Feasibility and return on investment (ROI) calculations for automating these ideas may be provided, documentation for future automations may be collected, and collaboration may be provided to get from automation discovery to build-out faster.

Process mining (e.g., via UiPath Automation Cloud™ and/or UiPath AI Center™) refers to the process of gathering and analyzing the data from applications (e.g., enterprise resource planning (ERP) applications, customer relation management (CRM) applications, email applications, call center applications, etc.) to identify what end-to-end processes exist in an organization and how to automate them effectively, as well as indicate what the impact of the automation will be. This data may be gleaned from user computing systems 102, 104, 106 by listeners, for example, and processed by servers, such as server 130. One or more AI/ML models 132 may be employed for this purpose in some embodiments. This information may be exported to the automation hub to speed up implementation and avoid manual information transfer. The goal of process mining may be to increase business value by automating processes within an organization. Some examples of process mining goals include, but are not limited to, increasing profit, improving customer satisfaction, regulatory and/or contractual compliance, improving employee efficiency, etc.

Task mining (e.g., via UiPath Automation Cloud™ and/or UiPath AI Center™) identifies and aggregates workflows (e.g., employee workflows), and then applies AI to expose patterns and variations in day-to-day tasks, scoring such tasks for ease of automation and potential savings (e.g., time and/or cost savings). One or more AI/ML models 132 may be employed to uncover recurring task patterns in the data. Repetitive tasks that are ripe for automation may then be identified. This information may initially be provided by listeners and analyzed on servers of core hyper-automation system 120, such as server 130, in some embodiments. The findings from task mining (e.g., XAML process data) may be exported to process documents or to a designer application such as UiPath Studio™ to create and deploy automations more rapidly. Task mining in some embodiments may include taking screenshots with user actions (e.g., mouse click locations, keyboard inputs, application windows and graphical elements the user was interacting with, timestamps for the interactions, etc.), collecting statistical data (e.g., execution time, number of actions, text entries, etc.), editing and annotating screenshots, specifying types of actions to be recorded, etc.

Task capture (e.g., via UiPath Automation Cloud™ and/or UiPath AI Center™) automatically documents attended processes as users work or provides a framework for unattended processes. Such documentation may include desired tasks to automate in the form of process definition documents (PDDs), skeletal workflows, capturing actions for each part of a process, recording user actions and automatically generating a comprehensive workflow diagram including the details about each step, Microsoft Word documents, XAML files, and the like. Build-ready workflows may be exported directly to a designer application in some embodiments, such as UiPath Studio™. Task capture may simplify the requirements gathering process for both subject matter experts explaining a process and Center of Excellence (CoE) members providing production-grade automations.

Building automations may be accomplished via a designer application (e.g., UiPath Studio™, UiPath StudioX™, or UiPath Studio Web™). For instance, developers of an RPA development facility 150 may use designer applications 154 of computing systems 152 to build and test agentic automations, RPAs, AOPs, and/or composite automations for various applications and environments, such as web, mobile, SAPR, and virtualized desktops. Developers may also build AOPs. For instance, developers may create automations to be executed by RPA robots, AI agents, AOPs, a combination thereof, etc. API integration may be provided for various applications, technologies, and platforms. Predefined activities, drag-and-drop modeling, and a workflow recorder may make automation easier with minimal coding. Document understanding functionality may be provided via drag-and-drop AI skills for data extraction and interpretation that call one or more AI/ML models 132. Such automations may process virtually any document type and format, including tables, checkboxes, signatures, and handwriting. When data is validated or exceptions are handled, this information may be used to retrain the respective AI/ML models, improving their accuracy over time.

Designer application 152 may be designed to call one or more of trained AI/ML models 132 on server 130 and/or generative AI models 172 in a cloud environment via network 119 (e.g., a LAN, a mobile communications network, a satellite communications network, the Internet, any combination thereof, etc.) to assist with the automation development process. In some embodiments, one or more of the AI/ML models may be packaged with designer application 152 or otherwise stored locally on computing system 154.

In some embodiments, designer application 152 and one or more of AI/ML models 132 may be configured to use an object repository stored in database 140. See, for example, U.S. Pat. No. 11,748,069, which is hereby incorporated by reference in its entirety. Generally speaking, an object repository is a storage mechanism used by automations for images, text, semantic data, taxonomical associations, ontological associations, UI objects, etc. For example, the object repository may include libraries of UI objects that can be used to develop workflows via designer application 152. The object repository may be used to add UI descriptors to activities in the workflows of RPA designer application 152 for UI automations. In some embodiments, one or more of AI/ML models 132 may generate new UI descriptors and add them to the object repository in database 140.

Once automations are completed in designer application 152, they may be published on server 130, pushed out to computing systems 102, 104, 106, etc. For example, as new UI descriptors are created and/or existing UI descriptors are modified, a global repository of UI object libraries may be built that is sharable and collaborative for all automations. Regarding object repositories, taxonomies and ontologies may be used. A taxonomy is a hierarchical structure of subcategories. An ontology is a formal representation of a domain of knowledge, including concepts, properties, and relationships therebetween. In an ontology, the relationships between categories are not necessarily hierarchical, and the ontological relationship may span multiple screens of an application.

An integration service may allow developers to seamlessly combine UI automation with API automation, for example. Automations, such as the types described herein, may be built that require APIs or traverse both API and non-API applications and systems. A repository (e.g., UiPath Object Repository™) or marketplace (e.g., UiPath Marketplace™) for pre-built automation templates and solutions may be provided to allow developers to automate a wide variety of processes more quickly. Thus, when building automations, hyper-automation system 100 may provide user interfaces, development environments, API integration, pre-built and/or custom-built AI/ML models, development templates, integrated development environments (IDEs), and advanced AI capabilities. Hyper-automation system 100 enables development, deployment, management, configuration, monitoring, debugging, and maintenance of RPA robots and AI agents in some embodiments, which may provide automations for hyper-automation system 100.

In some embodiments, components of hyper-automation system 100, such as designer application(s) and/or an external rules engine, provide support for managing and enforcing governance policies for controlling various functionality provided by hyper-automation system 100. Governance is the ability for organizations to put policies in place to prevent users from developing automations (e.g., RPA robots and/or AI agents) capable of taking actions that may harm the organization, such as violating the E.U. General Data Protection Regulation (GDPR), the U.S. Health Insurance Portability and Accountability Act (HIPAA), third party application terms of service, etc. Since developers may otherwise create automations that violate privacy laws, terms of service, etc. while performing their automations, some embodiments implement access control and governance restrictions at the automation and/or automation design application level. This may provide an added level of security and compliance to the automation process development pipeline in some embodiments by preventing developers from taking dependencies on unapproved software libraries that may either introduce security risks or work in a way that violates policies, regulations, privacy laws, and/or privacy policies. See, for example, U.S. Pat. No. 11,733,668, which is hereby incorporated by reference in its entirety.

The management functionality may provide management, deployment, and optimization of automations across an organization. The management functionality may include orchestration, test management, AI functionality, and/or insights in some embodiments. Management functionality of hyper-automation system 100 may also act as an integration point with third-party solutions and applications for automation applications and/or RPA robots. The management capabilities of hyper-automation system 100 may include, but are not limited to, facilitating provisioning, deployment, configuration, queuing, monitoring, logging, and interconnectivity of RPA robots and/or AI agents, among other things.

A conductor application, such as UiPath Orchestrator™ (which may be provided as part of the UiPath Automation Cloud™ in some embodiments, or on premises, in VMs, in a private or public cloud, in a Linux™ VM, or as a cloud native single container suite via UiPath Automation Suite™), provides orchestration capabilities to deploy, monitor, optimize, scale, and ensure security of RPA robot and/or AI agent deployments. A test suite (e.g., UiPath Test Suite™) may provide test management to monitor the quality of deployed automations. The test suite may facilitate test planning and execution, meeting of requirements, and defect traceability. The test suite may include comprehensive test reporting.

Analytics software (e.g., UiPath Insights™) may track, measure, and manage the performance of deployed automations. The analytics software may align automation operations with specific key performance indicators (KPIs) and strategic outcomes for an organization. The analytics software may present results in a dashboard format for better understanding by human users.

A data service (e.g., UiPath Data Service™) may be stored in database 140, for example, and bring data into a single, scalable, secure place with a drag-and-drop storage interface. Some embodiments may provide low-code or no-code data modeling and storage to automations while ensuring seamless access, enterprise-grade security, and scalability of the data. AI functionality may be provided by an AI center (e.g., UiPath AI Center™), which facilitates incorporation of AI/ML models into automations. Pre-built AI/ML models, model templates, and various deployment options may make such functionality accessible even to those who are not data scientists. Deployed automations (e.g., RPA robots and/or AI agents) may call AI/ML models from the AI center, such as AI/ML models 132.

Performance of the AI/ML models may be monitored and be trained and improved using human-validated data, such as that provided by data review center 160. Human reviewers may provide labeled data to core hyper-automation system 120 via a review application 162 on computing systems 164. For instance, human reviewers may validate that predictions by AI/ML models 132 are accurate or provide corrections otherwise. Human reviewers may also provide dynamic direct user input (e.g., within the scope of human-in-the-loop operations) to AI agents, and the responses and corrections provided by the human reviewers may be used to train LLM(s) used by AI agents to be more accurate. In other words, this dynamic input may then be saved as training data for retraining AI/ML models 132 and/or generative AI models 172 and may be stored in a database such as database 140, for example. The AI center may then schedule and execute training jobs to train the new versions of the AI/ML models using the training data. Both positive and negative examples may be stored and used for retraining of AI/ML models 132 and/or generative AI models 172.

The engagement functionality engages humans and automations as one team for seamless collaboration on desired processes. Low-code applications may be built (e.g., via UiPath Apps™) to connect browser tabs and legacy software, even that lacking APIs in some embodiments. Applications may be created quickly using a web browser through a rich library of drag-and-drop controls, for instance. An application can be connected to a single automation or multiple automations.

An action center (e.g., UiPath Action Center™) provides a straightforward and efficient mechanism to hand off processes from automations to humans, and vice versa. Humans may provide approvals or escalations, make exceptions, etc. The automation may then perform the automatic functionality of a given workflow.

A local assistant may be provided as a launchpad for users to launch automations (e.g., UiPath Assistant™). Such an assistant may also provide semantic cut-and-paste functionality (e.g., UiPath Clipboard AI™). See, for example, U.S. Pat. No. 12,124,806 and U.S. Patent Application Publication Nos. 2023/0107316, 2023/0415338, and 2024/0220581. This functionality may be provided in a tray provided by an operating system, for example, and may allow users to interact with RPA robots and RPA robot-powered applications on their computing systems. An interface may list automations approved for a given user and allow the user to run them. These may include ready-to-go automations from an automation marketplace, an internal automation store in an automation hub, etc. When automations run, they may run as a local instance in parallel with other processes on the computing system so users can use the computing system while the automation performs its actions. In certain embodiments, the assistant is integrated with the task capture functionality such that users can document their soon-to-be-automated processes from the assistant launchpad.

End-to-end measurement and government of an automation program at any scale may be provided by hyper-automation system 100 in some embodiments. Per the above, analytics may be employed to understand the performance of automations (e.g., via UiPath Insights™). Data modeling and analytics using any combination of available business metrics and operational insights may be used for various automated processes. Custom-designed and pre-built dashboards allow data to be visualized across desired metrics, new analytical insights to be discovered, performance indicators to be tracked, ROI to be discovered for automations, telemetry monitoring to be performed on user computing systems, errors and anomalies to be detected, and automations to be debugged. An automation management console (e.g., UiPath Automation Ops™) may be provided to manage automations throughout the automation lifecycle. An organization may govern how automations are built, what users can do with them, and which automations users can access.

Hyper-automation system 100 provides an iterative platform in some embodiments. Processes can be discovered, automations can be built, tested, and deployed, performance may be measured, use of the automations may readily be provided to users, feedback may be obtained, AI/ML models may be trained and retrained, and the process may repeat itself. This facilitates a more robust and effective suite of automations.

In some embodiments, per the above, generative AI models are used. For instance, AI agents make use of generative AI models. Generative AI can generate various types of content, such as text, imagery, audio, and synthetic data. various types of generative AI models may be used, including, but not limited to, LLMs, generative adversarial networks (GANs), diffusion models, flow-based models, variational autoencoders (VAEs), transformers, etc. In the case of LLMs, for example, NLP models such as word2vec, BERT, GPT-4, ChatGPT, etc. may be used in some embodiments to facilitate semantic understanding and provide more accurate and human-like answers.

These models may be part of AI/ML models 132 hosted on server 130. For instance, the generative AI models may be trained on a large corpus of textual information to perform semantic understanding, to understand the nature of what is present on a screen from text, to automatically generate code, and the like. AI agents may use such generative AI models. In certain embodiments, generative AI models 172 provided by an existing cloud ML service provider, such as OpenAIR, Google, Amazon®, Microsoft®, IBM, Nvidia®, Meta®, etc., may be employed and trained to provide such functionality. In generative AI embodiments where generative AI model(s) 172 are remotely hosted, server 130 can be configured to integrate with third-party APIs, which allow server 130 to send a request to generative AI model(s) 172 including the requisite input information and receive a response in return (e.g., the semantic matches of fields between application versions and/or screens, a classification of the type of the application on the screen, responses to natural language queries from users, etc.). Such embodiments may provide a more advanced and sophisticated user experience, as well as provide access to state-of-the-art NLP and other ML capabilities that these companies offer.

One aspect of generative AI models in some embodiments is the use of transfer learning. In transfer learning, a pretrained generative AI model, such as an LLM, is fine-tuned on a specific task or domain. This allows the LLM to leverage the knowledge already learned during its initial training and adapt it to a specific application. In the case of LLMs, the pretraining phase involves training an LLM on a large corpus of text, typically consisting of billions of words. During this phase, the LLM learns the relationships between words and phrases, which enables the LLM to generate coherent and human-like responses to text-based inputs. The output of this pretraining phase is an LLM that has a high level of understanding of the underlying patterns in natural language.

In the fine-tuning phase, the pretrained LLM is adapted to a specific task or domain by training the LLM on a smaller dataset that is specific to the task. For instance, in some embodiments, the LLM may be trained to analyze a certain type or multiple types of data sources to improve its accuracy with respect to their content. This data may include, but is not limited to, prompt tuning or instruction tuning, where the model is specifically trained to better understand and follow certain types of instructions or prompts, improving its ability to perform specific tasks when given appropriate instructions. Such information may be provided as part of the training data, and the LLM may learn to focus on these areas and more accurately identify data elements therein. Fine-tuning allows the LLM to learn the nuances of the task or domain, such as the specific vocabulary and syntax used in that domain, without requiring as much data as would be necessary to train an LLM from scratch. By leveraging the knowledge learned in the pretraining phase, the fine-tuned LLM can achieve state-of-the-art performance on specific tasks with a relatively small amount of training data.

LLMs may use a vector database. Vector databases index, store, and provide access to structured or unstructured data (e.g., text, images, time series data, etc.) alongside the vector embeddings thereof. Data such as text may be tokenized, where single letters, words, or sequences of words are parsed from the text into tokens. These tokens are then “embedded” into vector embeddings, which are the numerical representations of this data. Vector databases enable LLMs to find and retrieve similar objects quickly and at scale in production environments, which is not possible via manual processes.

AI and ML allow unstructured data to be numerically represented without losing the semantic meaning thereof in vector embeddings. A vector embedding is a long list of numbers, each describing a feature of the data object that the vector embedding represents. Similar objects are grouped together in the vector space. In other words, the more similar the objects are, the closer that the vector embeddings representing the objects will be to one another. Similar objects may be found using a vector search, similarity search, or semantic search. The distance between the vector embeddings may be calculated using various techniques including, but not limited to, squared Euclidean or L2-squared distance, Manhattan or L1 distance, cosine similarity, dot product, Hamming distance, etc. It may be beneficial to select the same metric that is used to train the AI/ML model.

Vector indexing may be used to organize vector embeddings so data can be retrieved efficiently. Calculating the distance between a vector embedding and all other vector embeddings in the vector database using the k-Nearest Neighbors (kNN) algorithm can be computationally expensive if there are a large number of data points since the required calculations increase linearly (O(n)) with the dimensionality and the number of data points. It is more efficient to find similar objects using an approximate nearest neighbor (ANN) approach. The distances between the vector embeddings are pre-calculated, and similar vectors are organized and stored close to one another (e.g., in clusters or a graph) similar objects can be found faster. This process is called “vector indexing.” ANN algorithms that may be used in some embodiments include, but are not limited to, clustering-based indexing, proximity graph-based indexing, tree-based indexing, hash-based indexing, compression-based indexing, etc.

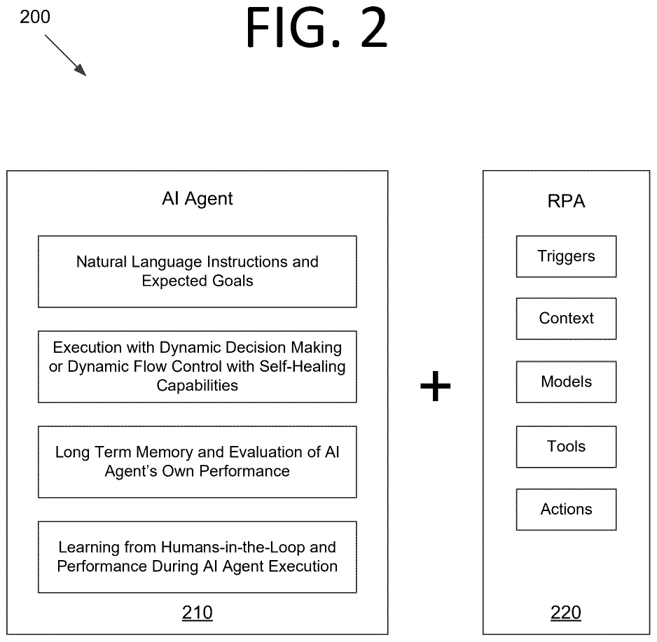

FIG. 2 illustrates some of the combined capabilities 200 of an AI agent 210 and an RPA robot 220, according to an embodiment of the present invention. AI agent 210 is configured to process natural language instructions and achieve expected goals therefrom, execute with dynamic decision making or dynamic flow control with self-healing capabilities, store information in long term memory and evaluate its own execution performance, and learn from humans-in-the-loop and its own performance during execution. RPA robot 220 can be leveraged by AI agent 210 to respond to triggers (e.g., from a conductor application such as UiPath Orchestrator™), to respond based on context (i.e., RPA robot 220 can retrieve information from the context to execute deterministic steps, such as updating a document based on the retrieved information from the context; alternatively, agent 210 can use the retrieved context to update a dynamic plan and execute the next steps complete the goals as per the instructions), to leverage AI models (e.g., CV models, document processing models, speech-to-text models, OCR models, etc.), leverage RPA tools (e.g., utilize tools available in the RPA ecosystem, such as complete automations, workflows within automations, integration service connector calls for 3^{rd} party and 1^{st} party services, RPA designer application activities, LLM calls, etc.), and perform actions that an RPA robot can take (i.e., use the RPA robot as a tool) based on input from the AI agent. AI agent 210 can also take actions to update its memory, update the plan to accomplish its goals per instructions, self-evaluate and learn from the actions, self-heal when it encounters roadblocks, and escalate to humans when it needs help.

As discussed above, various technical effects, benefits, and advantages may be achieved via agentic automation in some embodiments. Agentic automation improves memory usage by requiring less storage for data and increases processor efficiency by reducing the number of calls and actions. Agentic automation also potentially provides the ability to process gigabytes, terabytes, petabytes, or more, of data that would not be possible by human-implemented processes, whether mental or by hand. It also potentially enables fewer triggers and models to be used via dynamic decision making. Whereas RPA alone may require 100 actions in an example scenario, using agentic automation, this may be reduced substantially (e.g., to 15 actions). Context grounding may also be employed to tether the AI agent to the desired context for the agentic automation. This “constrains” the LLM to a pertinent context.

As used herein, “context grounding” refers to a methodology to improve models, such as LLMs, by integrating enterprise-specific information with pretrained knowledge, enabling accurate responses to specialized or recent queries. In some embodiments, context grounding uses external data to augment the LLM response and get a response that the LLM does not know about innately and answer queries on top of the context provided. By way of example, because unique industry terminology and complex document structures can pose challenges in ensuring effective retrieval and semantic matching, context grounding solves challenges by providing precise chunking of documents to ensure relevant information (e.g., from the unique industry terminology and complex document structures) can be passed to an LLM without noise. By way of an additional example, context grounding provides enhanced extraction and search techniques tailored to diverse industries and applications (e.g., tailored to the unique industry terminology and complex document structures) that improves the LLM response.

FIG. 3 illustrates pools 300 of AOPs, AI agents, RPA robots, and applications, according to an embodiment of the present invention. AOP pool 310 includes AOPs 1, 2, . . . , P that implement business processes. Per the above, the AOPs may be implemented as BPMN, which is executed by an AOP execution engine, such as Temporal®. AOPs can utilize AI agents and/or RPA robots to execute parts of the business process.

AI agent pool 320 includes AI agents 1, 2, . . . ,/that have been trained to perform various tasks, such as investigating claims, seeking resolution with human employees, summarizing policies and technical specifications, etc. RPA robot pool 330 includes RPA robots 1, 2, . . . , J that execute various automations, such as UI automations, semantic matching automations, form filling automations, etc. Application pool 340 includes applications 1, 2, . . . , K that the AI agents and/or RPA robots can interact with. For instance, the applications may include CRM applications, invoicing applications, payroll applications, banking applications, web applications, legacy system applications, word processing applications, spreadsheet applications, email applications, etc. The AI agents, RPA robots, and applications may be on a single computing system or on multiple or many computing systems. AOPs are typically in the cloud or otherwise server side and may be on the same computing system(s) as conductor application 350 in some embodiments.

The AOPs can trigger or call the AI agents and RPA robots via conductor application 350. The AI agents and RPA robots can also trigger or call one another via conductor application. For instance, to call an RPA robot, the AI agent may make a “Start Job” call in conductor application 350. It should be noted that the RPA robots are deployed as automations that are controlled by conductor application 350. The AI agents and RPA robots can also trigger or call certain applications. For instance, via information gleaned from human-in-the-loop actions, the AI agents may dynamically learn which RPA robots, other AI agents, and/or applications to trigger or call to achieve a task. For instance, an AI agent may learn to trigger an RPA robot via conductor application 350 to fill out and submit a web form. The AI agent may also learn to open Microsoft Excel® and enter the form information into appropriate tabs, open and update a payroll application, etc. The AI agent may further learn to call or trigger an email resolution AI agent via conductor application 350 that reaches out to a human customer service representative of a bank if an issue occurs. The technical effects, benefits, and advantages may be similar to those discussed above with respect to FIGS. 1 and 2 in some embodiments.

In order for AI agents and RPA robots to find one another, the AI agents may belong to a tenant. The designer application may call the conductor to get the list of available RPAs. There are three ways for getting the capabilities of automations in some embodiments: (1) the user provides a description of what the automation does while creating the workflow in the designer application; (2) AI agents and ML techniques are used to generate a summary of what a given workflow does; or (3) the developer can describe what the automation does in the designer application. The conductor application may also have lists of what applications are available to given AI agents and RPA robots. In other words, descriptions of available AI agents, RPA robots, and/or applications are derived from or assigned by AI agents, ML techniques, or users.

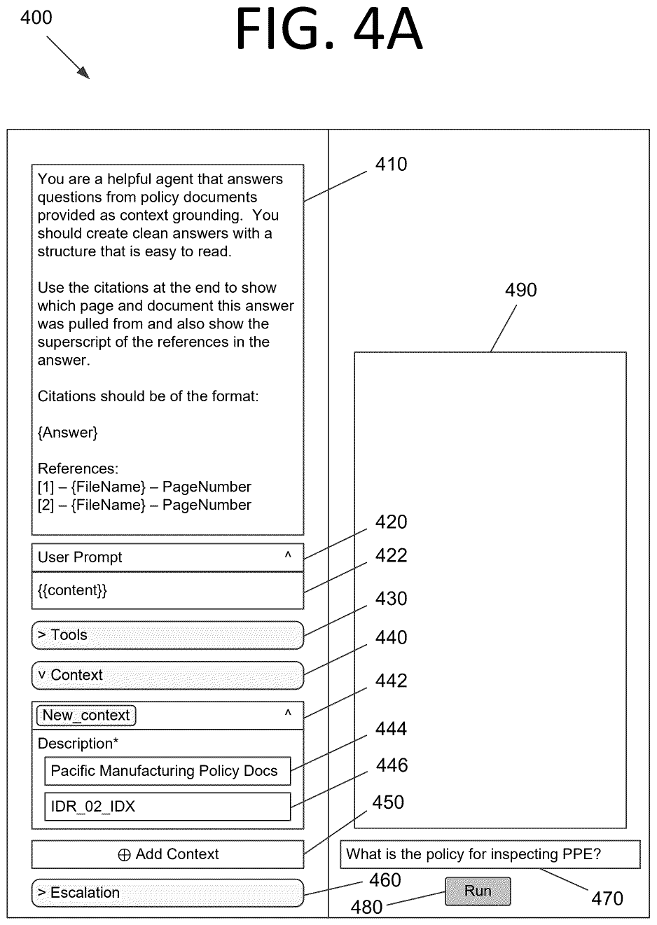

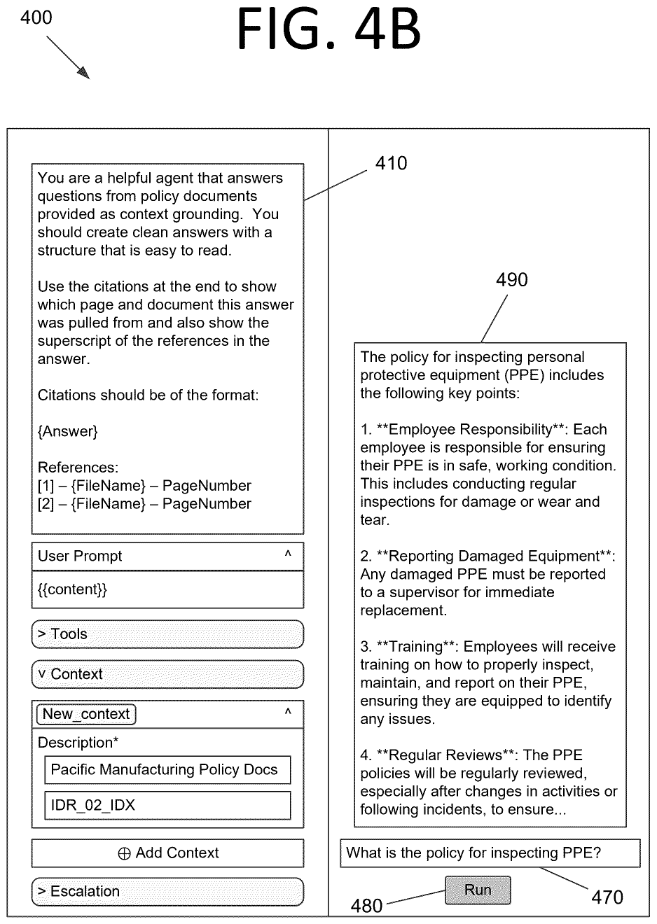

FIGS. 4A and 4B illustrate an example agent service interface 400, according to an embodiment of the present invention. Referring to FIG. 4A, the agent answers questions regarding policy documents that are provided within context grounding. An agent instructions pane 410 includes a natural language description entered by a user of what the AI agent is intended to do. A user prompt 420 allows the developer to enter content for a user prompt in a content field 422, if desired. Tools dropdown 430 allows the developer to select tools that the AI agent will utilize, such as using APIs for applications, calling RPA robots to execute RPAs, etc.

A context dropdown 440 allows the developer to configure the context grounding for the AI agent. A context configuration pane 442 allows the developer to provide a description via description field 444 and an Elastic Common Schema (ECS) index via ECS index field 446 for specific policy documents that have information regarding contracts, stipulation and what to do, etc. in this example. The developer can also add additional context 450 to further supplement the context grounding. Human escalation options can be configured via dropdown 460.

A query field 470 allows the user to provide a query that the AI agent will respond to. The AI agent runs the query when the user clicks run button 480. Turning to FIG. 4B, the results during AI agent execution are then shown in execution pane 490 as the AI agent retrieves and outputs them.

FIG. 5 illustrates an example AOP development interface 500, according to an embodiment of the present invention. AOP development interface 500 includes AOP components 510, AI agents 520, and RPAs 530 that the user can select when developing a business process. These can be selected and dragged to a canvas 540 where the user can manually develop the AOP. In this example, a credit check is implemented by getting customer data from a database, calling an AI agent to determine a customer type (e.g., highly likely to pay, likely to miss payments, frequently between jobs, etc.) by analyzing the customer data. The type is then provided to an RPA robot that takes this information into account when performing a credit check. Alternatively, the AOP developer can type a description of the business process into field 550 and click a generate button 560. This text is provided to an LLM, which attempts to understand the requested business process and automatically create the AOP workflow. The AOP developer can then edit the AOP workflow as desired.

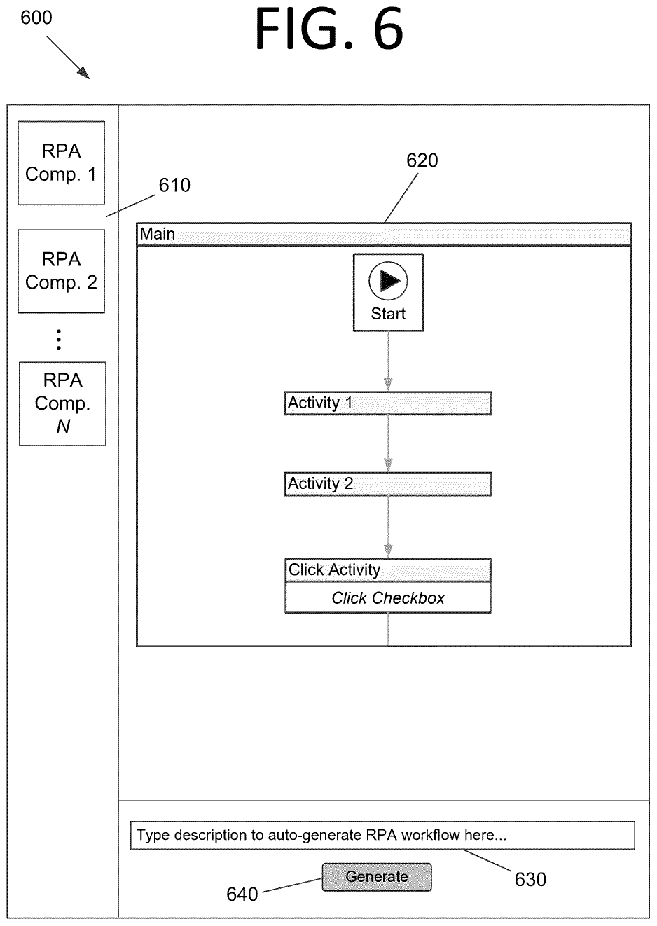

FIG. 6 illustrates an example RPA development interface 600, according to an embodiment of the present invention. RPA development interface 600 includes RPA components 610 that the user can select when developing an RPA workflow. These can be selected and dragged to a canvas 620. Alternatively, the RPA developer can type a description of the RPA into field 630 and click a generate button 640. This text is provided to an LLM, which attempts to understand the requested business process and automatically create the RPA workflow. The developer can then edit the RPA workflow as desired. It should be noted that the functionality shown and described with respect to FIGS. 4A, 4B, 5 and 6 may be provided in a single designer application in some embodiments.

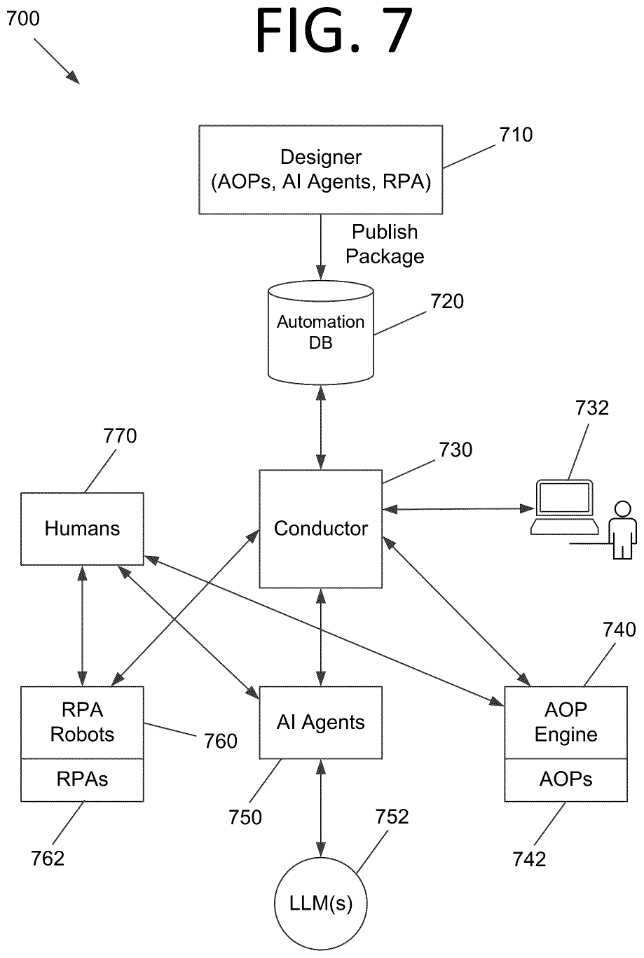

FIG. 7 illustrates an end-to-end AI agent, RPA robot, and AOP development and deployment system 700, according to an embodiment of the present invention. A designer application 710 allows developers to design AOPs, AI agents, and RPA workflows. Once these have been tested and validated, they are packaged and published to an automation database 720.

A conductor application 730 manages deployments of these automations, as well as of AOPs, AI agents, and RPA robots. When a human user or software process 732 requests that an AOP be run, conductor application 730 sends a start job request to AOP engine 740, which selects and starts the appropriate automation from AOPs 742. When executing AOP 742, steps may be encountered that are implemented by AI agents 750 or RPA robots 760. When this occurs, AOP engine 740 suspends the AOP workflow execution and sends a request to conductor application 730 to send a start job request to an appropriate AI agent 750 or RPA robot 760 to execute the step.

In the case of an AI agent being requested, conductor application 730 sends the start job request to the appropriate AI agent 750. This request may include natural language text or other information provided by AOP engine 740 to conductor application 730. AI agent 750 then performs the step by executing an LLM 752 to assist in carrying out the task. AI agent 750 then sends information pertinent to the task (e.g., requested information, an indication that the step was completed, an indication that the step failed, etc.) to conductor 730, which provides this information to AOP engine 740. AOP engine 740 then resumes its operation.

In the case of an RPA robot being requested, conductor application 730 sends the start job request to the appropriate RPA robot 760. RPA robot 760 then executes a requested RPA 762. RPA robot 760 then sends information pertinent to the task (e.g., requested information, an indication that the step was completed, an indication that the step failed, etc.) to conductor 730, which provides this information to AOP engine 740. AOP engine 740 then resumes its operation.

In some cases, human action may be required by an AOP 742, an AI agent 750, or an RPA 762. In this case, AOP engine 740, AI agent 750, or RPA robot 760 contacts a human 770 for the human-in-the-loop portion of the automation. After the human completes the task, the AOP engine 740, AI agent 750, or RPA robot 760 resumes the automated portion of the automation.

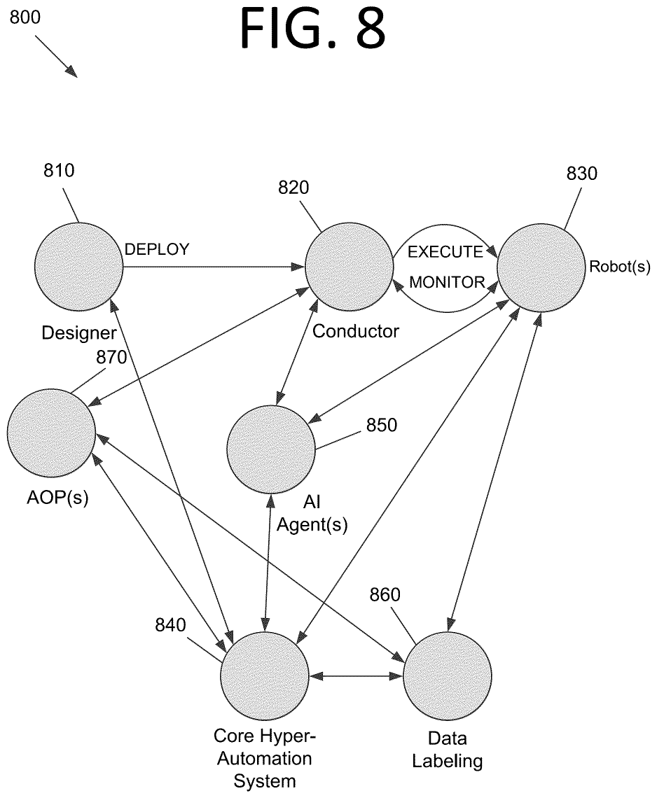

FIG. 8 is an architectural diagram illustrating an agentic automation and RPA system 800, according to an embodiment of the present invention. In some embodiments, agentic automation and RPA system 800 is part of hyper-automation system 100 of FIG. 1. Agentic automation and RPA system 800 includes a designer 810 that allows a developer to design automations for AI agents and RPA robots (e.g., workflows, natural language instructions for AI agents, context grounding, tool configurations, etc.). Designer 810 may provide a solution for application integration, as well as automating third-party applications, administrative information technology (IT) tasks, and business IT processes. Designer 810 may facilitate development of an automation project, which is a graphical representation of a business process. Simply put, designer 810 facilitates the development and deployment of automations for RPA robots and AI agents. In some embodiments, designer 810 may be an application that runs on a user's desktop, an application that runs remotely in a VM, a web application, etc.

The automation project enables automation of rule-based processes by giving the developer control of the execution order and the relationship between a custom set of steps developed in a workflow, i.e., “activities,” per the above. One commercial example of an embodiment of designer 810 is UiPath Studio™. Each activity may include an action, such as clicking a button, reading a file, writing to a log panel, etc. In some embodiments, workflows may be nested or embedded.

Some types of workflows may include, but are not limited to, sequences, flowcharts, finite state machines (FSMs), and/or global exception handlers. Sequences may be particularly suitable for linear processes, enabling flow from one activity to another without cluttering a workflow. Flowcharts may be particularly suitable to more complex business logic, enabling integration of decisions and connection of activities in a more diverse manner through multiple branching logic operators. FSMs may be particularly suitable for large workflows. FSMs may use a finite number of states in their execution, which are triggered by a condition (i.e., transition) or an activity. Global exception handlers may be particularly suitable for determining workflow behavior when encountering an execution error and for debugging processes.

Once a workflow and/or other configuration for an AI agent is developed in designer 810, execution of business processes is orchestrated by a conductor 820, which orchestrates one or more robots 830, one or more AI agents 850, and/or one or more AOPs 870 that execute the workflows developed in designer 810. One commercial example of an embodiment of conductor 820 is UiPath Orchestrator™. Conductor 820 facilitates management of the creation, monitoring, and deployment of resources in an environment. Conductor 820 may act as an integration point with third-party solutions and applications. Per the above, in some embodiments, conductor 820 may be part of core hyper-automation system 120 of FIG. 1.

It should be noted that RPA robots 830 may operate independently for deterministic processes. AI agents 850 and AOPs 870 can also operate independently (e.g., for non-deterministic processes) or utilize RPA robot(s) 830 or other AI agents 850 as tools to accomplish part of their agentic automations. AI agents 850 can drive composite automations that utilize both RPA robots 830 and AI agents 850, or vice versa, and AOPs 870 may include such composite automations.

Conductor 820 may manage a fleet of robots 830 and AI agents 850, connecting and executing robots 830 and AI agents 850 from a centralized point (e.g., as requested by an AOP engine that is implementing an AOP). Types of robots 830 that may be managed include, but are not limited to, attended robots, unattended robots, development robots (similar to unattended robots, but used for development and testing purposes), and nonproduction robots (similar to attended robots, but used for development and testing purposes). Attended robots are triggered by user events and operate alongside a human on the same computing system. Attended robots may be used with conductor 820 for a centralized process deployment and logging medium. Attended robots may help the human user accomplish various tasks, and may be triggered by user events. In some embodiments, processes cannot be started from conductor 820 on this type of robot and/or they cannot run under a locked screen. In certain embodiments, attended robots can only be started from a robot tray or from a command prompt. Attended robots should run under human supervision in some embodiments.

Unattended robots run unattended in virtual environments and can automate many processes. Unattended robots may be responsible for remote execution, monitoring, scheduling, and providing support for work queues. Debugging for all robot types may be run in designer 810 in some embodiments. Both attended and unattended robots may automate various systems and applications including, but not limited to, mainframes, web applications, VMs, enterprise applications (e.g., those produced by SAP®, SalesForce®, Oracle®, etc.), and computing system applications (e.g., desktop and laptop applications, mobile device applications, wearable computer applications, etc.).

Conductor 820 may have various capabilities including, but not limited to, provisioning, deployment, versioning, configuration, queueing, monitoring, logging, and/or providing interconnectivity. Provisioning may include creating and maintenance of connections between robots 830, AI agents 850, and/or AOPs 870 and conductor 820 (e.g., a web application). Deployment may include assuring the correct delivery of package versions to assigned robots 830, AI agents 850, and/or AOPs 870 for execution. Configuration may include maintenance and delivery of RPA robot and AI agent environments and process configurations. Queueing may include providing management of queues and queue items. Monitoring may include keeping track of RPA robot and AI agent identification data and maintaining user permissions. Logging may include storing and indexing logs to a database (e.g., a structured query language (SQL) database or a “not only” SQL (NoSQL) database) and/or another storage mechanism (e.g., ElasticSearch®, which provides the ability to store and quickly query large datasets). Conductor 820 may provide interconnectivity by acting as the centralized point of communication for third-party solutions and/or applications.

RPA robots 830 are execution agents that run workflows built in designer 810. One commercial example of some embodiments of robot(s) 830 is UiPath Robots™. In some embodiments, RPA robots 830 install the Microsoft Windows® Service Control Manager (SCM)-managed service by default. As a result, such RPA robots 830 can open interactive Windows® sessions under the local system account, and have the rights of a Windows® service.

In some embodiments, RPA robots 830 can be installed in a user mode. For such robots 830, this means they have the same rights as the user under which a given robot 830 has been installed. This feature may also be available for high density (HD) robots, which ensure full utilization of each machine at its maximum potential. In some embodiments, any type of RPA robot 830 may be configured in an HD environment.

RPA robots 830 in some embodiments are split into several components, each being dedicated to a particular automation task. The robot components in some embodiments include, but are not limited to, SCM-managed robot services, user mode robot services, executors, agents, and command line. SCM-managed robot services manage and monitor Windows® sessions and act as a proxy between conductor 820 and the execution hosts (i.e., the computing systems on which robots 830 are executed). These services are trusted with and manage the credentials for RPA robots 830. A console application is launched by the SCM under the local system.

User mode robot services in some embodiments manage and monitor Windows® sessions and act as a proxy between conductor 820 and the execution hosts. User mode robot services may be trusted with and manage the credentials for RPA robots 830. A Windows® application may automatically be launched if the SCM-managed robot service is not installed.

Executors may run given jobs under a Windows® session (i.e., they may execute workflows. Executors may be aware of per-monitor dots per inch (DPI) settings. Agents may be Windows Presentation Foundation (WPF) applications that display the available jobs in the system tray window. It should be noted that these agents differ from AI agents 850. Agents may be a client of the service. Agents may request to start or stop jobs and change settings. The command line is a client of the service. The command line is a console application that can request to start jobs and waits for their output.

Having components of robots 830 split as explained above helps developers, support users, and computing systems more easily run, identify, and track what each component is executing. Special behaviors may be configured per component this way, such as setting up different firewall rules for the executor and the service. The executor may always be aware of DPI settings per monitor in some embodiments. As a result, workflows may be executed at any DPI, regardless of the configuration of the computing system on which they were created. Projects from designer 810 may also be independent of browser zoom level in some embodiments. For applications that are DPI-unaware or intentionally marked as unaware, DPI may be disabled in some embodiments.

Agentic automation and RPA system 800 in this embodiment is part of a hyper-automation system, such as hyper-automation system 100 of FIG. 1. Developers may use designer 810 to build and test RPAs, AOPs, and AI agents that utilize AI/ML models deployed in core hyper-automation system 840 (e.g., as part of an AI center thereof). Such RPA robots, AOPs, and AI agents may send input for execution of the AI/ML model(s) and receive output therefrom via core hyper-automation system 840.

One or more of robots 830 may be listeners, as described above. These listeners may provide information to core hyper-automation system 840 regarding what users are doing when they use their computing systems. This information may then be used by core hyper-automation system for process mining, task mining, task capture, etc.

An assistant/chatbot (not shown) may be provided on user computing systems to allow users to launch local RPA robots. The assistant may be located in a system tray, for example. Chatbots may have a user interface so users can see text in the chatbot. Alternatively, chatbots may lack a user interface and run in the background, listening using the computing system's microphone for user speech.

In some embodiments, data labeling may be performed by a user of the computing system on which an RPA robot or AI agent is executing or on another computing system that the RPA robot or AI agent provides information to. For instance, if a robot calls an AI/ML model that performs CV on images for VM users, but the AI/ML model does not correctly identify a button on the screen, the user may draw a rectangle around the misidentified or non-identified component and potentially provide text with a correct identification. This information may be provided to core hyper-automation system 840 and then used later for training a new version of the AI/ML model.

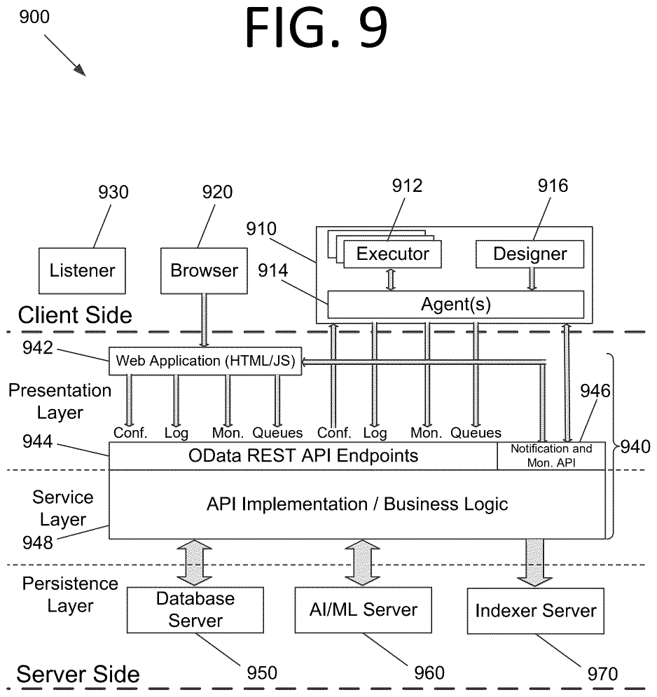

FIG. 9 is an architectural diagram illustrating a deployed RPA system 900, according to an embodiment of the present invention. In some embodiments, RPA system 900 may be, or may be a part of, agentic automation and RPA system 800 of FIG. 8 and/or hyper-automation system 100 of FIG. 1. It should be noted that the architecture of deployed RPA system 900 may be a cloud-based system, an on-premises system, a desktop-based system that offers enterprise level, user level, or device level automation solutions for automation of different computing processes, etc.

It should also be noted that the client side, the server side, or both, may include any desired number of computing systems without deviating from the scope of the invention. On the client side, a robot application 910 includes executors 912, an execution agent 914, and a designer 916. However, in some embodiments, designer 916 may not be running on computing system 910. Executors 912 are running processes. Several business projects may run simultaneously. Execution agent 914 (e.g., a Windows® service) is the single point of contact for all executors 912 in this embodiment. All messages in this embodiment are logged into conductor 940, which processes them further via a database server 950, an AI/ML server 960, an indexer server 970, or any combination thereof. As discussed above with respect to FIG. 8, executors 912 may be robot components.

In some embodiments, an RPA robot represents an association between a machine name and a username. The robot may manage multiple executors at the same time. On computing systems that support multiple interactive sessions running simultaneously (e.g., Windows Server 2012), multiple robots may be running at the same time, each in a separate Windows® session using a unique username. This is referred to as HD robots above.

Execution agent 914 is also responsible for sending the status of the robot (e.g., periodically sending a “heartbeat” message indicating that the robot is still functioning) and downloading the required version of the package to be executed. The communication between execution agent 914 and conductor 940 is always initiated by execution agent 914 in some embodiments. In the notification scenario, execution agent 914 may open a WebSocket channel that is later used by conductor 940 to send commands to the RPA robot (e.g., start, stop, etc.).

It should be noted that, while not shown here in order to reduce clutter in FIG. 9, AI agents can also interact with conductor 940, as discussed above with respect to FIGS. 1 and 8, for example. Conductor 940 may orchestrate the operations of the AI agents. Conductor 940 may also facilitate interaction between the AI agents and AI/ML models via AI/ML server 960, which may store and/or facilitate access to generative AI models.

A listener 930 monitors and records data pertaining to user interactions with an attended computing system and/or operations of an unattended computing system on which listener 930 resides. Listener 930 may be an RPA robot, part of an operating system, a downloadable application for the respective computing system, or any other software and/or hardware without deviating from the scope of the invention. Indeed, in some embodiments, the logic of the listener is implemented partially or completely via physical hardware.

On the server side, a presentation layer (web application 942, Open Data Protocol (OData) Representative State Transfer (REST) Application Programming Interface (API) endpoints 944, and notification and monitoring 946), a service layer (API implementation/business logic 948), and a persistence layer (database server 950, AI/ML server 960, and indexer server 970) are included. Conductor 940 includes web application 942, OData REST API endpoints 944, notification and monitoring 946, and API implementation/business logic 948. In some embodiments, most actions that a user performs in the interface of conductor 940 (e.g., via browser 920) are performed by calling various APIs. Such actions may include, but are not limited to, starting jobs on robots, adding/removing data in queues, scheduling jobs to run unattended, etc. without deviating from the scope of the invention. Web application 942 is the visual layer of the server platform. In this embodiment, web application 942 uses Hypertext Markup Language (HTML) and JavaScript (JS). However, any desired markup languages, script languages, or any other formats may be used without deviating from the scope of the invention. The user interacts with web pages from web application 942 via browser 920 in this embodiment in order to perform various actions to control conductor 940. For instance, the user may create robot groups, assign packages to the robots, analyze logs per robot and/or per process, start and stop robots, etc.

In addition to web application 942, conductor 940 also includes service layer that exposes OData REST API endpoints 944. However, other endpoints may be included without deviating from the scope of the invention. The REST API is consumed by both web application 942 and execution agent 944. Execution agent 914 is the supervisor of one or more robots on the client computer in this embodiment.

The REST API in this embodiment covers configuration, logging, monitoring, and queueing functionality. The configuration endpoints may be used to define and configure application users, permissions, robots, assets, releases, and environments in some embodiments. Logging REST endpoints may be used to log different information, such as errors, explicit messages sent by the robots, and other environment-specific information, for instance. Deployment REST endpoints may be used by the robots to query the package version that should be executed if the start job command is used in conductor 940. Queueing REST endpoints may be responsible for queues and queue item management, such as adding data to a queue, obtaining a transaction from the queue, setting the status of a transaction, etc.

Monitoring REST endpoints may monitor web application 942 and execution agent 914. Notification and monitoring API 946 may be REST endpoints that are used for registering execution agent 914, delivering configuration settings to execution agent 914, and for sending/receiving notifications from the server and execution agent 914. Notification and monitoring API 946 may also use WebSocket communication in some embodiments.

The APIs in the service layer may be accessed through configuration of an appropriate API access path in some embodiments, e.g., based on whether conductor 940 and an overall hyper-automation system have an on-premises deployment type or a cloud-based deployment type. APIs for conductor 940 may provide custom methods for querying stats about various entities registered in conductor 940. Each logical resource may be an OData entity in some embodiments. In such an entity, components such as the robot, process, queue, etc., may have properties, relationships, and operations. APIs of conductor 940 may be consumed by web application 942 and/or execution agents 914 in two ways in some embodiments: by getting the API access information from conductor 940, or by registering an external application to use the OAuth flow.

The persistence layer includes a trio of servers in this embodiment-database server 950 (e.g., a SQL server), AI/ML server 960, and indexer server 970. Database server 950 in this embodiment stores the configurations of the robots, robot groups, associated processes, users, roles, schedules, etc. This information is managed through web application 942 in some embodiments. Database server 950 may manage queues and queue items. In some embodiments, database server 950 may store messages logged by the RPA robots (in addition to or in lieu of indexer server 970).

Database server 950 may also store process mining, task mining, and/or task capture-related data, received from listener 930 installed on the client side, for example. While no arrow is shown between listener 930 and database 950, it should be understood that listener 930 is able to communicate with database 950, and vice versa in some embodiments. This data may be stored in the form of PDDs, images, XAML files, etc. Listener 930 may be configured to intercept user actions, processes, tasks, and performance metrics on the respective computing system on which listener 930 resides. For example, listener 930 may record user actions (e.g., clicks, typed characters, locations, applications, active elements, times, etc.) on its respective computing system and then convert these into a suitable format to be provided to and stored in database server 950.

AI/ML server 960 facilitates incorporation of AI/ML models into automations. Pre-built AI/ML models, model templates, and various deployment options may make such functionality accessible even to those who are not data scientists. Deployed automations (e.g., RPA robots and/or AI agents) may call AI/ML models from AI/ML server 960. Performance of the AI/ML models may be monitored, and be trained and improved using human-validated data. AI/ML server 960 may schedule and execute training jobs to train new versions of the AI/ML models. AI/ML model server may also store and/or access generative AI models.

AI/ML server 960 may store data pertaining to AI/ML models and ML packages for configuring various ML skills for a user at development time. An ML skill, as used herein, is a pre-built and trained ML model for a process, which may be used by an automation, for example. AI/ML server 960 may also store data pertaining to document understanding technologies and frameworks, algorithms and software packages for various AI/ML capabilities including, but not limited to, intent analysis, NLP, speech analysis, different types of AI/ML models, etc.

Indexer server 970, which is optional in some embodiments, stores and indexes the information logged by the RPA robots and/or AI agents. In certain embodiments, indexer server 970 may be disabled through configuration settings. In some embodiments, indexer server 970 uses ElasticSearch, which is an open source project full-text search engine. Messages logged by RPA robots and/or AI agents (e.g., using activities like log message or write line) may be sent through the logging REST endpoint(s) to indexer server 970, where they are indexed for future utilization.

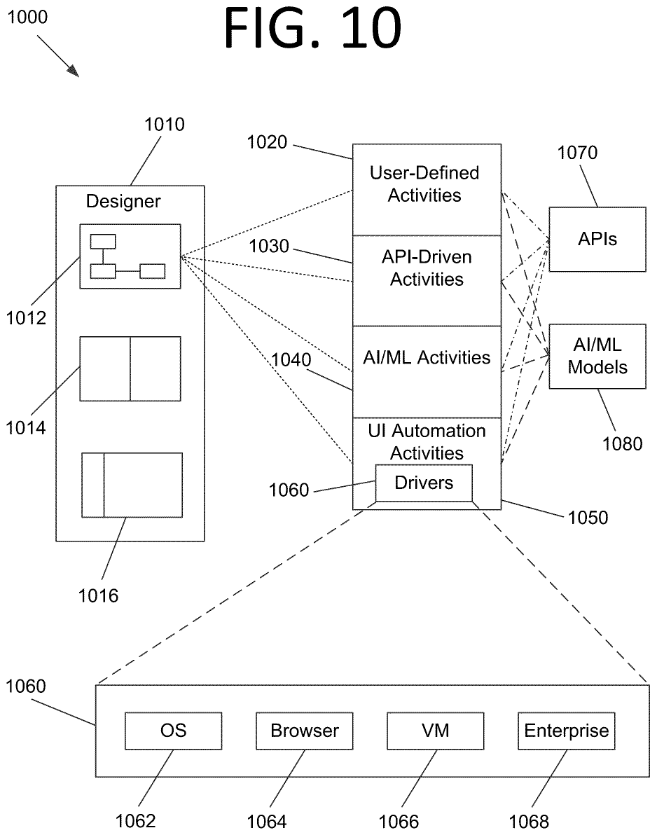

FIG. 10 is an architectural diagram illustrating the relationship 1000 between a designer 1010, activities 1020, 1030, 1040, 1050, drivers 1060, APIs 1070, and AI/ML models 1080, according to an embodiment of the present invention. Per the above, a developer uses designer 1010 to develop workflows that are executed by RPA robots, AI agents, and AOP engines. The developer can design and configure RPA robot workflows 1012, design and configure agentic automations 1014 for AI agents (e.g., providing natural language descriptions, context grounding, tools, etc. for AI agents), and design and configure AOPs 1016. See FIGS. 4A, 4B, 5, and 6, for example. The various types of activities may be displayed to the developer in some embodiments. Designer 1010 may be local to the user's computing system or remote thereto (e.g., accessed via VM or a local web browser interacting with a remote web server). Workflows for RPA robots may include user-defined activities 1020, UI automation activities 1030, AI/ML activities 1040, and/or UI automation activities 1050. User-defined activities 1020 and API-driven activities 1040 interact with applications via their APIs. User-defined activities 1020 and/or AI/ML activities 1040 may call one or more AI/ML models 1080 in some embodiments, which may be located locally to the computing system on which the robot is operating and/or remotely thereto.

Some embodiments are able to identify non-textual visual components in an image, which is called CV herein. However, it should be noted that in some embodiments, CV incorporates OCR. CV may be performed at least in part by AI/ML model(s) 1080. Some CV activities pertaining to such components may include, but are not limited to, extracting of text from segmented label data using OCR, fuzzy text matching, cropping of segmented label data using ML, comparison of extracted text in label data with ground truth data, etc. In some embodiments, there may be hundreds or even thousands of activities that may be implemented in user-defined activities 1010. However, any number and/or type of activities may be used without deviating from the scope of the invention.

UI automation activities 1050 are a subset of special, lower level activities that are written in lower level code (e.g., CV activities) and facilitate interactions with the screen. UI automation activities 1050 facilitate these interactions via drivers 1060 that allow the RPA robot to interact with the desired software. For instance, drivers 1060 may include OS drivers 1062, browser drivers 1064, VM drivers 1066, enterprise application drivers 1068, etc.

One or more of AI/ML models 1080 may be used by UI automation activities 1050 in order to perform interactions with the computing system in some embodiments. In certain embodiments, AI/ML models 1080 may augment drivers 1060 or replace them completely. Indeed, in certain embodiments, drivers 1060 are not included.

Drivers 1060 may interact with the OS at a low level looking for hooks, monitoring for keys, etc. via OS drivers 1062. Drivers 1060 may facilitate integration with Chrome™, IER, Citrix*, SAPR, etc. For instance, the “click” activity performs the same role in these different applications via drivers 1060.

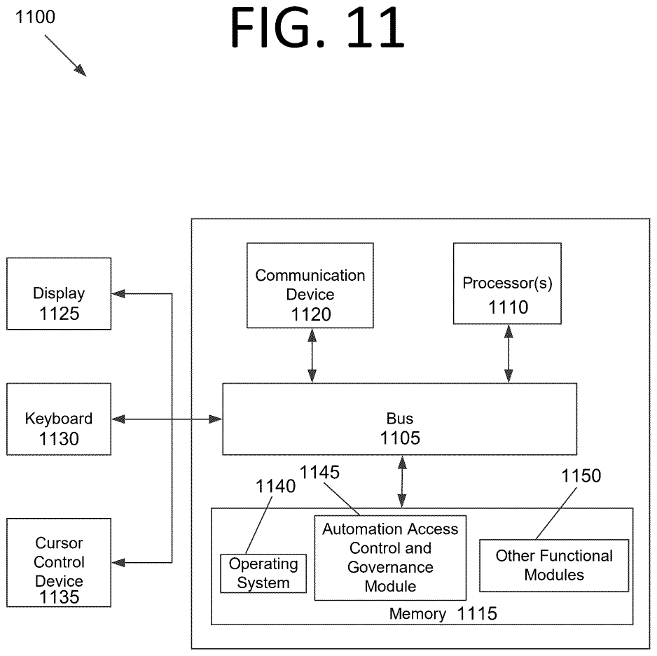

FIG. 11 is an architectural diagram illustrating a computing system 1100 configured to perform access control and governance for automations, according to an embodiment of the present invention. In some embodiments, computing system 1100 may be one or more of the computing systems depicted and/or described herein. In certain embodiments, computing system 1100 may be part of a hyper-automation system, such as that shown in FIGS. 1 and 8.

Computing system 1100 includes a bus 1105 or other communication mechanism for communicating information, and processor(s) 1110 coupled to bus 1105 for processing information. Processor(s) 1110 may be any type of general or specific purpose processor, including a Central Processing Unit (CPU), an Application Specific Integrated Circuit (ASIC), a Field Programmable Gate Array (FPGA), a Graphics Processing Unit (GPU), multiple instances thereof, and/or any combination thereof. Processor(s) 1110 may also have multiple processing cores, and at least some of the cores may be configured to perform specific functions. Multi-parallel processing may be used in some embodiments. In certain embodiments, at least one of processor(s) 1110 may be a neuromorphic circuit that includes processing elements that mimic biological neurons. In some embodiments, neuromorphic circuits may not require the typical components of a Von Neumann computing architecture.

Computing system 1100 further includes a memory 1115 for storing information and instructions to be executed by processor(s) 1110. Memory 1115 can be comprised of any combination of Random Access Memory (RAM), Read Only Memory (ROM), flash memory, cache, static storage such as a magnetic or optical disk, or any other types of non-transitory computer-readable media or combinations thereof. Non-transitory computer-readable media may be any available media that can be accessed by processor(s) 1110 and may include volatile media, non-volatile media, or both. The media may also be removable, non-removable, or both. Computing system 1100 includes a communication device 1120, such as a transceiver, to provide access to a communications network via a wireless and/or wired connection. In some embodiments, communication device 1120 may include one or more antennas that are singular, arrayed, phased, switched, beamforming, beamsteering, a combination thereof, and/or any other antenna configuration without deviating from the scope of the invention. Processor(s) 1110 are further coupled via bus 1105 to a display 1125. Any suitable display device and haptic I/O may be used without deviating from the scope of the invention.

A keyboard 1130 and a cursor control device 1135, such as a computer mouse, a touchpad, etc., are further coupled to bus 1105 to enable a user to interface with computing system 1100. However, in certain embodiments, a physical keyboard and mouse may not be present, and the user may interact with the device solely through display 1125 and/or a touchpad (not shown). Any type and combination of input devices may be used as a matter of design choice. In certain embodiments, no physical input device and/or display is present. For instance, the user may interact with computing system 1100 remotely via another computing system in communication therewith, or computing system 1100 may operate autonomously.

Memory 1115 stores software modules that provide functionality when executed by processor(s) 1110. The modules include an operating system 1140 for computing system 1100. The modules further include an automation access control and governance module 1145 that is configured to perform all or part of the processes described herein or derivatives thereof. Computing system 1100 may include one or more additional functional modules 1150 that include additional functionality.

One skilled in the art will appreciate that a “computing system” could be embodied as a server, an embedded computing system, a personal computer, a console, a personal digital assistant (PDA), a mobile phone, a tablet computing device, a smart watch, a quantum computing system, or any other suitable computing device, or combination of devices without deviating from the scope of the invention. Presenting the above-described functions as being performed by a “system” is not intended to limit the scope of the present invention in any way, but is intended to provide one example of the many embodiments of the present invention. Indeed, methods, systems, and apparatuses disclosed herein may be implemented in localized and distributed forms consistent with computing technology, including cloud computing systems. The computing system could be part of or otherwise accessible by a LAN, a mobile communications network, a satellite communications network, the Internet, a public or private cloud, a hybrid cloud, a server farm, any combination thereof, etc. Any localized or distributed architecture may be used without deviating from the scope of the invention.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, include one or more physical or logical blocks of computer instructions that may, for instance, be organized as an object, procedure, or function. Nevertheless, the executables of an identified module need not be physically located together, but may include disparate instructions stored in different locations that, when joined logically together, comprise the module and achieve the stated purpose for the module. Further, modules may be stored on a computer-readable medium, which may be, for instance, a hard disk drive, flash device, RAM, tape, and/or any other such non-transitory computer-readable medium used to store data without deviating from the scope of the invention.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

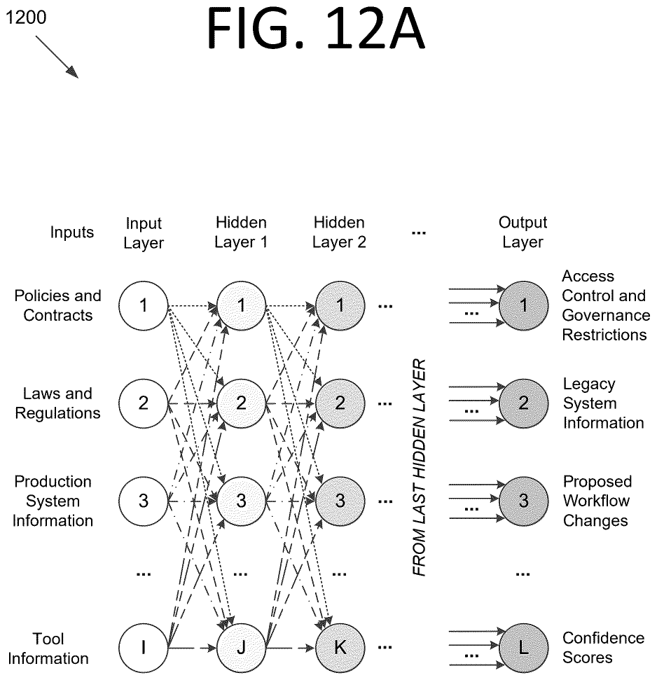

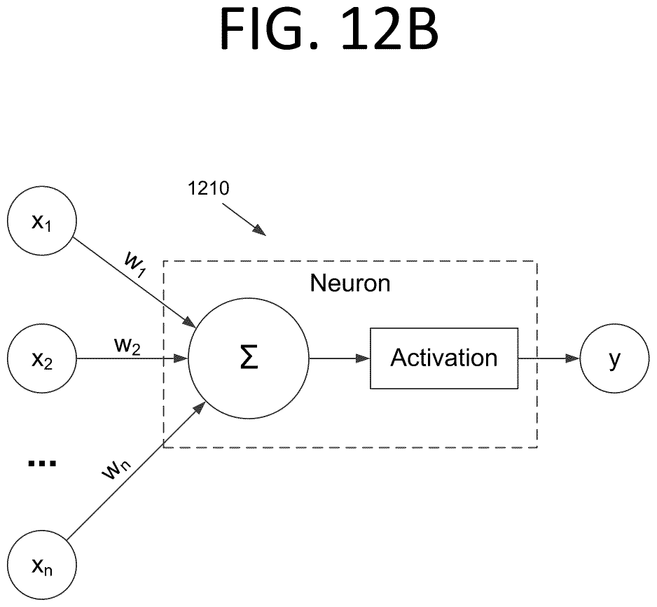

Various types of AI/ML models may be trained and deployed without deviating from the scope of the invention. For instance, FIG. 12A illustrates an example of a neural network 1200 that has been trained to assist with implementing access control and governance for automations, according to an embodiment of the present invention. Neural network 1200 includes a number of hidden layers. Both DLNNs and shallow learning neural networks (SLNNs) usually have multiple layers, although SLNNs may only have one or two layers in some cases, and normally fewer than DLNNs. Typically, the neural network architecture includes an input layer, multiple intermediate layers, and an output layer, as is the case in neural network 1200.

A DLNN often has many layers (e.g., 10, 50, 200, etc.) and subsequent layers typically reuse features from previous layers to compute more complex, general functions. A SLNN, on the other hand, tends to have only a few layers and train relatively quickly since expert features are created from raw data samples in advance. However, feature extraction is laborious. DLNNs, on the other hand, usually do not require expert features, but tend to take longer to train and have more layers.

For both approaches, the layers are trained simultaneously on the training set, normally checking for overfitting on an isolated cross-validation set. Both techniques can yield excellent results. The optimal size, shape, and quantity of individual layers varies depending on the problem that is addressed by the respective neural network.

Returning to FIG. 12A, policies and contracts, laws and regulations, production system information (e.g., hardware resources, legacy system restrictions, resource allocations for automations, etc.), tool information (e.g., software and APIs that AI agents can or cannot use), etc. are provided as the input layer and fed as inputs to the J neurons of hidden layer 1. The other information may include, but is not limited to, web browser histories, heat maps, key presses, mouse clicks, locations of mouse clicks and/or graphical elements on the displays that users are interacting with, locations where the users were looking on the displays, time stamps associated with the screenshots and video frames, text that the users entered, content that the users scrolled past, times that the users stopped on parts of content shown in the displays, what applications the user were interacting with, voice inputs, gestures, emotion information, biometrics, information pertaining to periods of no user activity, haptic information, multi-touch input information, any combination thereof, etc. The automation box information may include time stamped input from user input devices. While all of these inputs are fed to each neuron in this example, various architectures are possible that may be used individually or in combination including, but not limited to, feed forward networks, radial basis networks, deep feed forward networks, deep convolutional inverse graphics networks, convolutional neural networks, recurrent neural networks, artificial neural networks, long/short term memory networks, gated recurrent unit networks, generative adversarial networks, liquid state machines, auto encoders, variational auto encoders, denoising auto encoders, sparse auto encoders, extreme learning machines, echo state networks, Markov chains, Hopfield networks, Boltzmann machines, restricted Boltzmann machines, deep residual networks, Kohonen networks, deep belief networks, deep convolutional networks, support vector machines, neural Turing machines, or any other suitable type or combination of neural networks without deviating from the scope of the invention.

Hidden layer 2 receives inputs from hidden layer 1, hidden layer 3 receives inputs from hidden layer 2, and so on for all hidden layers until the last hidden layer provides its outputs as inputs for the output layer. In this embodiments, the outputs include access control and governance restrictions, legacy system information (e.g., computing system speeds and hardware information, software information, etc.), proposed workflow changes (e.g., to avoid conflicts with policies, laws, etc.), confidence scores, etc. While multiple suggestions are shown here as output, in some embodiments, only a single output suggestion is provided. In certain embodiments, the suggestions are ranked based on confidence scores.

It should be noted that the numbers of neurons I, J, K, and L are not necessarily equal. Thus, any desired number of layers may be used for a given layer of neural network 1200 without deviating from the scope of the invention. Indeed, in certain embodiments, the types of neurons in a given layer may not all be the same.

Neural network 1200 is trained to assign confidence score(s) to appropriate outputs. In order to reduce predictions that are inaccurate, only those results with a confidence score that meets or exceeds a confidence threshold may be provided in some embodiments. For instance, if the confidence threshold is 80%, outputs with confidence scores exceeding this amount may be used and the rest may be ignored.

Neural networks are probabilistic constructs that typically have confidence score(s). This may be a score learned by the AI/ML model based on how often a similar input was correctly identified during training. Some common types of confidence scores include a decimal number between 0 and 1 (which can be interpreted as a confidence percentage as well), a number between negative ∞ and positive ∞, a set of expressions (e.g., “low,” “medium,” and “high”), etc. Various post-processing calibration techniques may also be employed in an attempt to obtain a more accurate confidence score, such as temperature scaling, batch normalization, weight decay, negative log likelihood (NLL), etc.

“Neurons” in a neural network are implemented algorithmically as mathematical functions that are typically based on the functioning of a biological neuron. Neurons receive weighted input and have a summation and an activation function that governs whether they pass output to the next layer. This activation function may be a nonlinear thresholded activity function where nothing happens if the value is below a threshold, but then the function linearly responds above the threshold (i.e., a rectified linear unit (ReLU) nonlinearity). Summation functions and ReLU functions are used in deep learning since real neurons can have approximately similar activity functions. Via linear transforms, information can be subtracted, added, etc. In essence, neurons act as gating functions that pass output to the next layer as governed by their underlying mathematical function. In some embodiments, different functions may be used for at least some neurons.

An example of a neuron 1210 is shown in FIG. 12B. Inputs x₁, x₂, . . . , xₙ from a preceding layer are assigned respective weights w₁, w₂, . . . , wₙ. Thus, the collective input from preceding neuron 1 is w₁x₁. These weighted inputs are used for the neuron's summation function modified by a bias, such as:

$${\sum }_{i = 1}^{m} ( {w}_{i} {x}_{i} ) + bias \qquad ( 1 )$$

This summation is compared against an activation function ƒ(x) to determine whether the neuron “fires”. For instance, ƒ(x) may be given by:

$$f ( x ) = \{ \begin{matrix}1 if \sum wx + bias \geq 0 \\ 0 if \sum wx + bias < 0\end{matrix} \qquad ( 2 )$$

The output y of neuron 1210 may thus be given by:

$$y = f ( x ) {\sum }_{i = 1}^{m} ( {w}_{i} {x}_{i} ) + bias \qquad ( 3 )$$

In this case, neuron 1210 is a single-layer perceptron. However, any suitable neuron type or combination of neuron types may be used without deviating from the scope of the invention. It should also be noted that the ranges of values of the weights and/or the output value(s) of the activation function may differ in some embodiments without deviating from the scope of the invention.

A goal, or “reward function,” is often employed. A reward function explores intermediate transitions and steps with both short-term and long-term rewards to guide the search of a state space and attempt to achieve a goal (e.g., finding the most accurate answers to user inquiries based on associated metrics). During training, various labeled data is fed through neural network 1200. Successful identifications strengthen weights for inputs to neurons, whereas unsuccessful identifications weaken them. A cost function, such as mean square error (MSE) or gradient descent may be used to punish predictions that are slightly wrong much less than predictions that are very wrong. If the performance of the AI/ML model is not improving after a certain number of training iterations, a data scientist may modify the reward function, provide corrections of incorrect predictions, etc.

Backpropagation is a technique for optimizing synaptic weights in a feedforward neural network. Backpropagation may be used to “pop the hood” on the hidden layers of the neural network to see how much of the loss every node is responsible for and subsequently, updating the weights in such a way that minimizes the loss by giving the nodes with higher error rates lower weights, and vice versa. In other words, backpropagation allows data scientists to repeatedly adjust the weights so as to minimize the difference between actual output and desired output.

The backpropagation algorithm is mathematically founded in optimization theory. In supervised learning, training data with a known output is passed through the neural network and error is computed with a cost function from known target output, which gives the error for backpropagation. Error is computed at the output, and this error is transformed into corrections for network weights that will minimize the error.

In the case of supervised learning, an example of backpropagation is provided below. A column vector input x is processed through a series of N nonlinear activity functions fi between each layer i=1, . . . , N of the network, with the output at a given layer first multiplied by a synaptic matrix Wᵢ, and with a bias vector b; added. The network output o, given by

$$o = {f}_{N} ( {W}_{N} {f}_{N - 1} ( {W}_{N - 1} {f}_{N - 2} ( … {f}_{1} ( {W}_{1} x + {b}_{1} ) … ) + {b}_{N - 1} ) + {b}_{N} ) \qquad ( 4 )$$

In some embodiments, o is compared with a target output t, resulting in an error

$$E = \frac{1}{2} {‖ o - t ‖}^{2} ,$$

which is desired to be minimized.

Optimization in the form of a gradient descent procedure may be used to minimize the error by modifying the synaptic weights Wⁱ for each layer. The gradient descent procedure requires the computation of the output o given an input x corresponding to a known target output t, and producing an error o−t. This global error is then propagated backwards giving local errors for weight updates with computations similar to, but not exactly the same as, those used for forward propagation. In particular, the backpropagation step typically requires an activity function of the form

$${p}_{j} ( {n}_{j} ) = {f}_{j}^{′} ( {n}_{j} ) ,$$

where nⱼ is the network activity at layer j (i.e., nⱼ=Wⱼoⱼ₋₁+bⱼ) where oⱼ=ƒⱼ(nⱼ) and the apostrophe ′ denotes the derivative of the activity function ƒ.

The weight updates may be computed via the formulae:

$${d}_{j} = \{ \begin{matrix}( o - t ) ∘ {p}_{j} ( {n}_{j} ) , & j = N \\ {W}_{j + 1}^{T} {d}_{j + 1} ∘ {p}_{j} ( {n}_{j} ) , & j < N\end{matrix} \qquad ( 5 )$$

$$\frac{\partial E}{\partial {W}_{j + 1}} = {{d}_{j + 1} ( {o}_{j} )}^{T} \qquad ( 6 )$$

$$\frac{\partial E}{\partial {b}_{j + 1}} = {d}_{j + 1} \qquad ( 7 )$$

$${W}_{j}^{n e w} = {W}_{j}^{o l d} - η \frac{\partial E}{\partial {W}_{j}} \qquad ( 8 )$$

$${b}_{j}^{n e w} = {b}_{j}^{o l d} - η \frac{\partial E}{\partial {b}_{j}} \qquad ( 9 )$$

where ∘ denotes a Hadamard product (i.e., the element-wise product of two vectors), ^{T} denotes the matrix transpose, and oⱼ denotes ƒⱼ(Wⱼoⱼ₋₁+bⱼ), with o₀=x. Here, the learning rate η is chosen with respect to machine learning considerations. Below, η is related to the neural Hebbian learning mechanism used in the neural implementation. Note that the synapses W and b can be combined into one large synaptic matrix, where it is assumed that the input vector has appended ones, and extra columns representing the b synapses are subsumed to W.

The AI/ML model may be trained over multiple epochs until it reaches a good level of accuracy (e.g., 97% or better using an F2 or F4 threshold for detection and approximately 2,000 epochs). This accuracy level may be determined in some embodiments using an F1 score, an F2 score, an F4 score, or any other suitable technique without deviating from the scope of the invention. Once trained on the training data, the AI/ML model may be tested on a set of evaluation data that the AI/ML model has not encountered before. This helps to ensure that the AI/ML model is not “over fit” such that it performs well on the training data but does not perform well on other data.

In some embodiments, it may not be known what accuracy level is possible for the AI/ML model to achieve. Accordingly, if the accuracy of the AI/ML model is starting to drop when analyzing the evaluation data (i.e., the model is performing well on the training data, but is starting to perform less well on the evaluation data), the AI/ML model may go through more epochs of training on the training data (and/or new training data). In some embodiments, the AI/ML model is only deployed if the accuracy reaches a certain level or if the accuracy of the trained AI/ML model is superior to an existing deployed AI/ML model. In certain embodiments, a collection of trained AI/ML models may be used to accomplish a task. For example, one AI/ML model may be trained to recognize images, another may recognize text, yet another may perform CV, and still another may recognize semantic and/or ontological associations, etc.

It should be noted that in addition to or in lieu of neural networks, some embodiments may use transformer networks such as SentenceTransformers™, which is a Python™ framework for state-of-the-art sentence, text, and image embeddings. Such transformer networks learn associations of words and phrases that have both high scores and low scores. This trains the AI/ML model to determine what is close to the input and what is not, respectively. Rather than just using pairs of words/phrases, transformer networks may use the field length and field type, as well.

NLP models such as word2vec, BERT, GPT-3, ChatGPT, other LLMs, etc. may be used in some embodiments to facilitate semantic understanding and provide more accurate and human-like answers, per the above. Other techniques, such as clustering algorithms, may be used to find similarities between groups of elements. Clustering algorithms may include, but are not limited to, density-based algorithms, distribution-based algorithms, centroid-based algorithms, hierarchy-based algorithms. K-means clustering algorithms, the DBSCAN clustering algorithm, the Gaussian mixture model (GMM) algorithms, the balance iterative reducing and clustering using hierarchies (BIRCH) algorithm, etc. Such techniques may also assist with categorization.

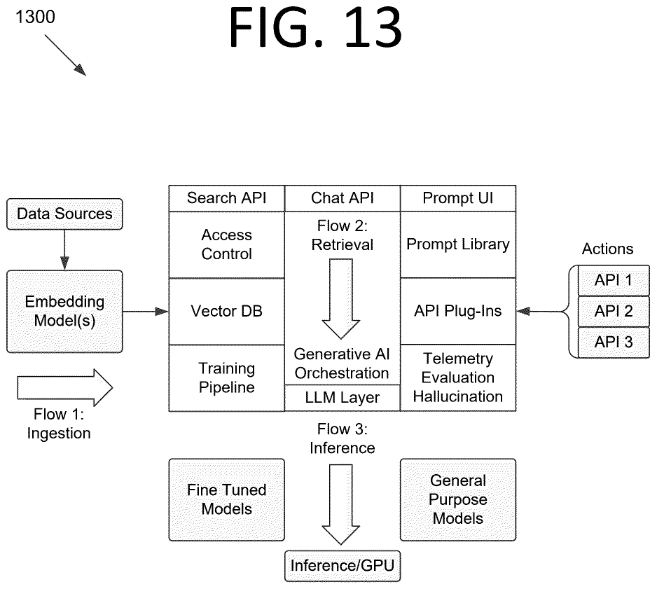

FIG. 13 is an architectural diagram illustrating a reference architecture 1300 for a generative AI model, according to an embodiment of the present invention. The architecture consists of several layers: API plug-ins, a prompt library, vector data source ingestion, access processing control, a model-training pipeline, an assessment layer to assess hallucination/telemetry/evaluations, a BYOM embedding layer, and an LLM orchestration layer. There are also retrieval plug-ins, access control plug-ins, and API plug-ins that integrate into enterprise systems.

There are three main flows in this embodiment:

Data Ingestion and Training Flow: Data is read from multiple data stores, preprocessed, chunked, and trained through an embedding model (e.g., retrieval augmented generation (RAG)) and a training pipeline (i.e., fine-tuning). The vector database stores the chunked document embeddings that allow for better semantic, similarity-based data retrievals.

Prompt Augmentation Using Data Retrieval: Once a user query arrives at the API layer, the prompt is selected, followed by data retrievals through the vector database or API plug-ins to get the right contextual data before the prompt is passed to the LLM layer.

LLM Inference: This is where there is a choice to use general purpose foundation models from or a self-hosted foundation model. Fine-tuned models may be used when tuned for a specific task or use case. The response is evaluated for accuracy and other metrics, including hallucinations.

It should be noted that in some embodiments, a generative AI model with multiple “heads” may be used. Heads refer to output layers of the generative AI model. Generative AI models, such as generative AI models 172 in FIG. 1, typically have a sequence of layers, and each head will often share the first few layers of the model before diverging into their own distinct layers.

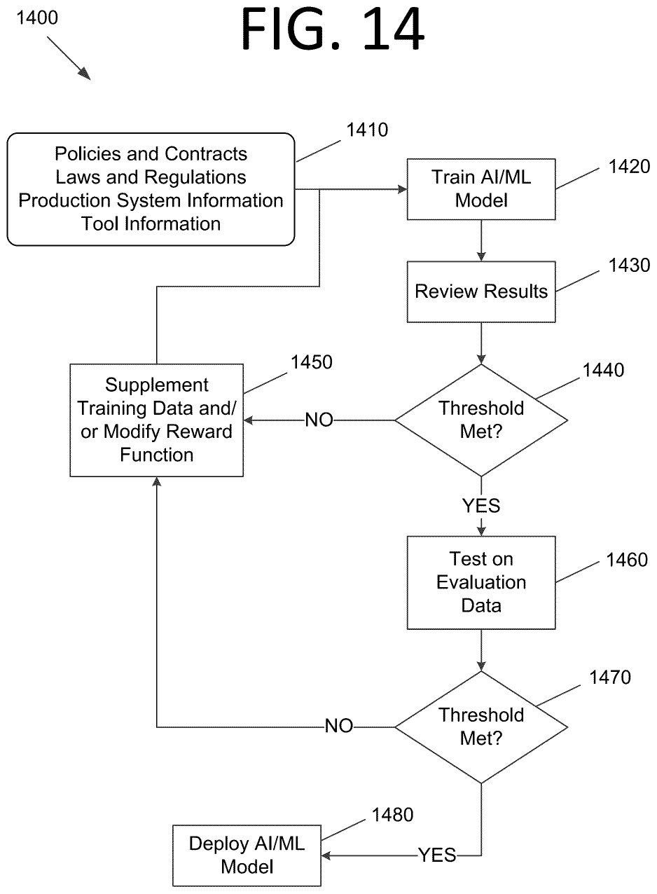

FIG. 14 is a flowchart illustrating a process 1400 for training AI/ML model(s), according to an embodiment of the present invention. In some embodiments, the AI/ML model(s) may be generative AI models, per the above. In the case of neural networks, the architecture typically includes multiple layers of neurons, including input, output, and hidden layers. See FIGS. 12A and 12B, for example. The input layer receives the input(s) and the output layer generates the response(s). The hidden layers in between process the input data and generate intermediate representations of the input that are used to generate the output. These hidden layers can include various types of neurons, such as convolutional neurons, recurrent neurons, and/or transformer neurons. Generative AI models may also have various layers.

The training process in some embodiments begins with providing policies and contracts, laws and regulations, production system information (e.g., hardware resources, legacy system restrictions, resource allocations for automations, etc.), tool information (e.g., software and APIs that AI agents can or cannot use), etc., whether labeled or unlabeled, at 1410. In the case of generative AI models, which are often generally trained, the training process may be skipped unless fine-tuned models are desired, as discussed in more detail below. The AI/ML model is then trained over multiple epochs at 1420 and results are reviewed at 1430. While various types of AI/ML models may be used, LLMs and other generative AI models are typically trained (fine-tuned) using a process called “supervised learning”, which is also discussed above. Supervised learning involves providing the model with a large dataset, which the model uses to learn the relationships between the inputs and outputs. During the training process, the model adjusts the weights and biases of the neurons in the neural network to minimize the difference between the predicted outputs and the actual outputs in the training dataset.

One aspect of the models in some embodiments is the use of transfer learning. For instance, transfer learning may take advantage of a pretrained model, such as ChatGPT, which is fine-tuned on a specific task or domain in step 1420. This allows the model to leverage the knowledge already learned from the pretraining phase and adapt it to a specific application via the training phase of step 1420.

The pretraining phase involves training the model on an initial set of training data that may be more general. During this phase, the model learns relationships in the data. In the fine-tuning phase (e.g., performed during step 1420 in addition to or in lieu of the initial training phase in some embodiments if a pretrained model is used as the initial basis for the final model), the pretrained model is adapted to a specific task or domain by training the model on a smaller dataset that is specific to the task. For instance, in some embodiments, the model may be focused on certain type(s) of data sources. This may help the model to more accurately identify data elements therein than a generative AI model that is pretrained alone. Fine-tuning allows the model to learn the nuances of the task, such as the specific vocabulary and syntax, certain graphical characteristics, certain data formats, etc., without requiring as much data as would be necessary to train the model from scratch. By leveraging the knowledge learned in the pretraining phase, the fine-tuned model can achieve state-of-the-art performance on specific tasks with relatively little additional training data.

If the AI/ML model fails to meet a desired confidence threshold at 1440 in some embodiments, the training data is supplemented and/or the reward function is modified to help the AI/ML model achieve its objectives better at 1450 and the process returns to step 1420. If the AI/ML model meets the confidence threshold at 1440, the AI/ML model is tested on evaluation data at 1460 to ensure that the AI/ML model generalizes well and that the AI/ML model is not over fit with respect to the training data. The evaluation data includes information that the AI/ML model has not processed before. If the confidence threshold is met at 1470 for the evaluation data, the AI/ML model is deployed at 1480. If not, the process returns to step 1450 and the AI/ML model is trained further.

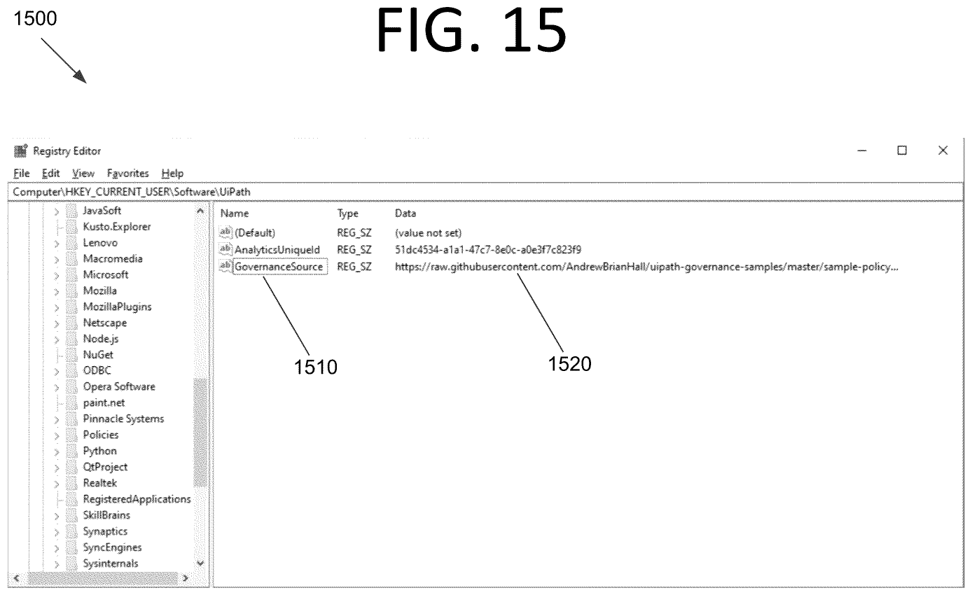

In some embodiments, the governance information for the automation designer application may be stored in a file that cannot be edited by the developer. For instance, FIG. 15 is a screenshot illustrating a view of a folder 1500 of the Windows® Registry Editor 1500 for the automation designer application (in this case, UiPath Studio™). Under the path Computer\HKEY_CURRENT_USER\Software\UiPath, a registry key named GovernanceSource 1510 is set (e.g. when the designer application is installed) that points to a remote policy file available via an associated link 1520. The policy available at this link may be read only to the computing system and will be used by the designer application or the automation (e.g., an RPA robot or an AI agent) to govern certain permissions. This policy may be defined at the individual user level, group level, role level, organization level, etc. By including the policy via a remote link, updates to the policy can be made whenever desired, and the updated policy will be automatically accessed by consuming automations and/or automation designer applications. In this example, the policy file provides the ability to define different sets of policies for the development profile. In some embodiments, different policies may be set for experienced programmers and for citizen developers who may not have programming knowledge since these developers may have different needs. A portion of an example policy file for UiPath Studio™ that defines rules for development users, business users, and StudioPro™ users is included below. The sections in bold specify where additional rules or counters may be defined in this example.

```
{
  ″Metadata″: {
    ″Version″: ″1.0″,
  },
  ″Info″: {
    ″Name″: ″Sample Policy Registry Key″
  },
  ″Profiles″: {
    ″Development″: {
      ″Shell″: {
        ″IsFeedbackEnabled″: true,
        ″HideGettingStartedScreen″: false
      },
      ″SourceControl″: {
        ″CheckInBeforePublish″: false
      },
      ″Workflow″: {
        ″DockedAnnotations″: true,
        ″AnalyzeOnPublish″: false,
        ″AnalyzeOnRun″: false
      }
      ″PackageManager″: {
        ″AllowAddRemoveFeeds″: false,
        ″AllowEnableDisableFeeds″: false,
        ″AllowOrchestratorFeeds″: true,
        ″Feeds″: [
          {
            ″Name″: ″Local″,
            ″Source″: ″C:\\Program Files
            (x86)\\UiPath\\Studio\\Packages″,
            ″IsEnabled″: true
          },
          {
            ″Name″: ″Official″,
            ″Source″: ″https://www.myget.org/F/workflow/″,
            ″IsEnabled″: true
          },
          {
            ″Name″: ″Connect″,
            ″Source″: ″https://gallery.uipath.com/api/v2″,
            ″IsEnabled″: true
          }
        ]
      },
      ″Analyzer″: {
        ″AllowEdit″: false,
        ″ReferencedRulesConfigFile″: null,
        ″EmbeddedRulesConfig″: {
          ″Rules″: [
            {
              ″Id″: ″ST-NMG-001″,
              ″IsEnabled″: true,
              ″Parameters″: [
                {
                  ″Name″: ″Regex″,
                  ″Value″: null
                }
              ],
              ″ErrorLevel″: ″Off″
            },
```

### Additional Rules Defined Here

```
],
″Counters″: [
  {
    ″Id″: ″ST-NMG-001″,
    ″IsEnabled″: true,
    ″Parameters″: []
  },
```

### Additional Counters Defined Here

```
      ]
    }
  }
},
″Business″: {
  ″Shell″: {
    ″IsFeedbackEnabled″: true,
    ″HideGettingStartedScreen″: false
  },
  ″SourceControl″: {
    ″CheckInBeforePublish″: false
  },
  ″Workflow″: {
    ″DockedAnnotations″: true,
    ″AnalyzeOnPublish″: false,
    ″AnalyzeOnRun″: false
  },
  ″PackageManager″: {
    ″AllowAddRemoveFeeds″: false,
    ″AllowEnableDisableFeeds″: false,
    ″AllowOrchestratorFeeds″: true,
    ″Feeds″: [
      {
        ″Name″: ″Local″,
        ″Source″: ″C:\\Program Files (x86)\\UiPath\\Studio\\Packages″,
        ″IsEnabled″: true
      },
      {
        ″Name″: ″Official″,
        ″Source″: ″https://www.myget.org/F/workflow/″,
        ″IsEnabled″: true
      },
      {
        ″Name″: ″Connect″,
        ″Source″: ″https://gallery.uipath.com/api/v2″,
        ″IsEnabled″: true
      }
    ]
  },
  ″Analyzer″: {
    ″AllowEdit″: false,
    ″ReferencedRulesConfigFile″: null,
    ″EmbeddedRulesConfig″: {
      ″Rules″: [
        {
          ″Id″: ″ST-NMG-001″,
          ″IsEnabled″: true,
          ″Parameters″: [
            {
              ″Name″: ″Regex″,
              ″Value″: null
            }
          ],
          ″ErrorLevel″: ″Off″
        },
```

### Additional Rules Defined Here

```
],
″Counters″: [
  {
    ″Id″: ″ST-NMG-001″,
    ″IsEnabled″: true,
    ″Parameters″: [ ]
  },
```

### Additional Counters Defined Here

```
      ]
    }
  }
},
″StudioPro″: {
  ″Shell″: {
    ″IsFeedbackEnabled″: true,
    ″HideGettingStartedScreen″: false
  },
  ″SourceControl″: {
    ″CheckInBeforePublish″: false
  },
    ″Workflow″:
      ″DockedAnnotations″: true,
      ″AnalyzeOnPublish″: false,
      ″AnalyzeOnRun″: false
  },
    ″PackageManager″: {
      ″AllowAddRemoveFeeds″: false,
      ″AllowEnableDisableFeeds″: false,
      ″AllowOrchestratorFeeds″: true,
      ″Feeds″: [
        {
          ″Name″: ″Local″,
          ″Source″: ″C:\\Program Files (x86)\\UiPath\\Studio\\Packages″,
          ″IsEnabled″: true
        },
        {
          ″Name″: ″Official″,
          ″Source″: ″https://www.myget.org/F/workflow/″,
          ″IsEnabled″: true
        },
        {
          ″Name″: ″Connect″,
          ″Source″: ″https://gallery.uipath.com/api/v2″,
          ″IsEnabled″: true
        }
      ]
    },
    ″Analyzer″: {
      ″AllowEdit″: false,
      ″ReferencedRulesConfigFile″: null,
      ″EmbeddedRulesConfig″: {
        ″Rules″: [
          {
            ″Id″: ″ST-NMG-001″,
            ″IsEnabled″: true,
            ″Parameters″: [
              {
                ″Name″: ″Regex″,
                ″Value″: null
              }
            ],
            ″ErrorLevel″: ″Off″
          },
```

### Additional Rules Defined Here

```
],
″Counters″: [
  {
    ″Id″: ″ ST-NMG-001″,
    ″IsEnabled″: true,
    ″Parameters″: [ ]
  },
```

### Additional Rules Defined Here

```
          ]
        }
      }
    }
  }
}
```

It should be noted that while the rules and counters shown here are the same for each user type, this need not necessarily be the case, and typically would not be in a practical implementation. It should also be noted that while a file including control and governance policy rules is obtained using a registry entry in some embodiments, in certain embodiments, the file or other policy information format is delivered from a by a conductor application. In certain embodiments, a server UI allows an administrator to define the policy, which will be delivered via a connection (e.g., as a json payload). However, this policy may not necessarily be “a file” that the administrator explicitly authors in some embodiments.

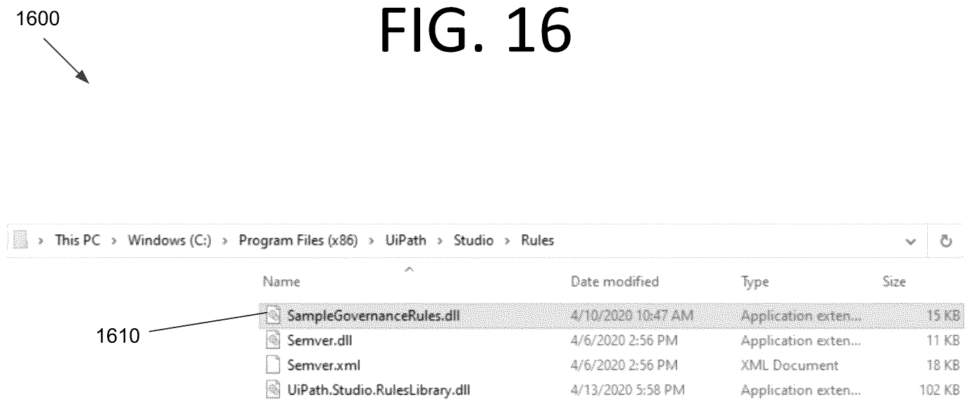

In some embodiments, custom governance rules may be developed as part of a workflow analyzer process. For instance, in some embodiments, the installation script for the designer application may install the custom governance rules to the user's computing system. See, for instance, screenshot 1600 of FIG. 16 which shows a portion of a Windows Explorer® UI, in which the file SampleGovernanceRules.dll 1610 is installed in the Rules folder for UiPath Studio™. Because SampleGovernanceRules.dll 1610 is located in the Program Files folder, only an administrator may modify it. An end user without administrative privileges on his or her machine cannot. Thus, the end user without such privileges will have the governance policy and will not be able to override or change it.

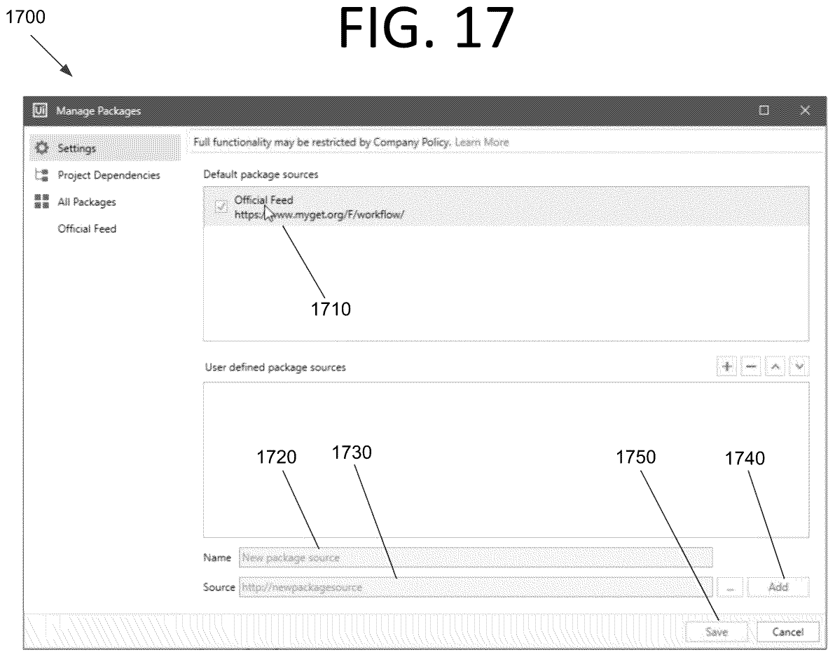

FIG. 17 is a screenshot illustrating a package management interface 1700, according to an embodiment of the present invention. In this embodiment, the package feeds for the developer have been locked down. More specifically, the developer only has access to official package feed 1710, and the developer cannot enable or disable official package feed 1710. The developer also cannot enter a name 1720 or source 1730 for a user-defined package, use add button 1740 to add the user-defined package, or use save button 1750 to save modified package settings. This prevents developers from getting activity packages from anywhere that the organization does not want them to.

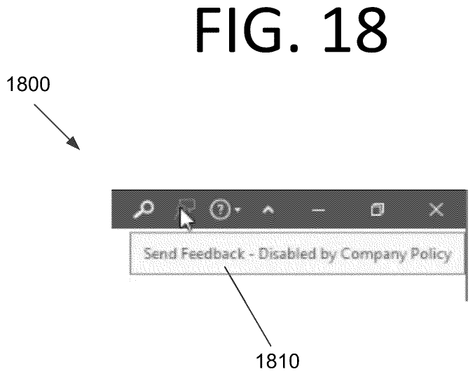

Some organizations may have concerns about developers potentially leaking sensitive information to the provider of the automation designer application during development. Accordingly, in some embodiments, the send feedback functionality is disabled in the designer application as a matter of policy. See, for example, FIG. 18, which is screenshot illustrating an upper right portion 1800 of a designer application with the send feedback icon disabled and a message 1810 indicating that this is the case.

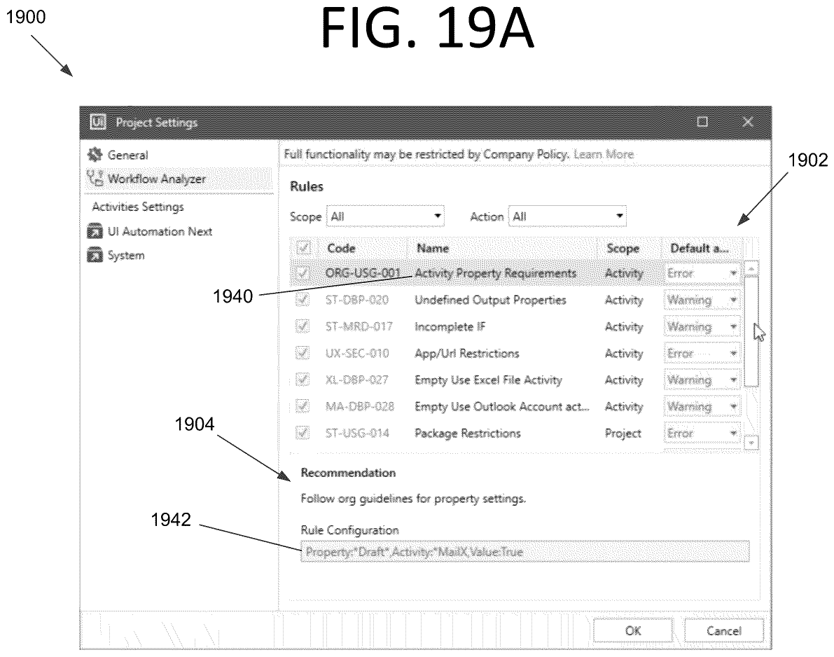

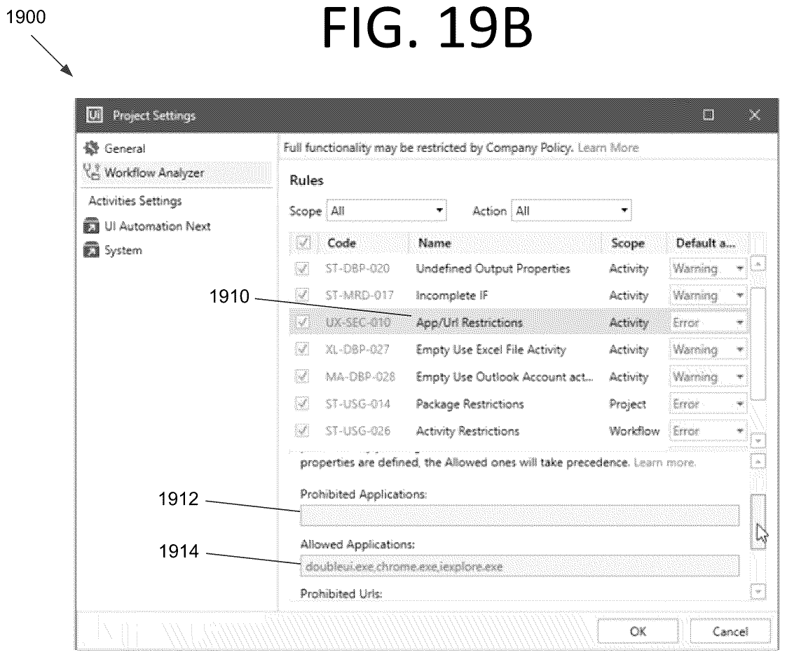

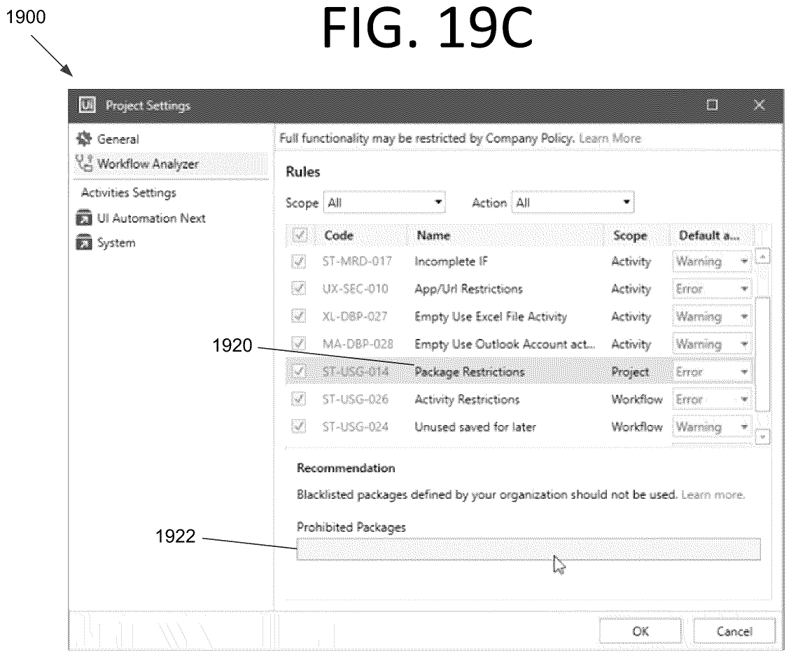

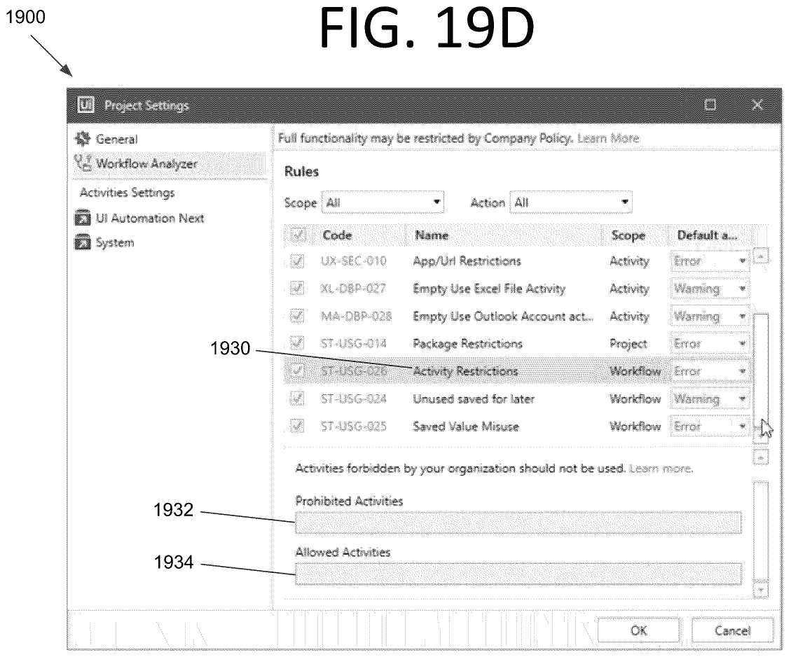

FIG. 19A is a screenshot illustrating a workflow analyzer settings interface 1900, according to an embodiment of the present invention. In some embodiments, the workflow analyzer settings are taken from a policy configuration file. As can be seen in FIG. 19A, various rules are listed in a rules pane 1902 with a respective code, name, scope, and default action. Specific settings options for a selected rule are shown in a rule settings pane 1904.

In this embodiment, there are four types of access restrictions-app/URL restrictions 1910, package restrictions 1920, activity restrictions 1930, and activity property requirements 1940. However, any number and/or type of access restrictions may be used without deviating from the scope of the invention. App/URL restrictions 1910 control which applications and/or URLs a user of the designer application is and/or is not allowed to work with. For instance, with reference to FIG. 19B, prohibited applications would be shown in prohibited applications field 1912 if any were prohibited and allowed applications are shown in allowed applications field 1914. If the user scrolled down, prohibited URLs and allowed URLs would also be shown in respective fields. Naturally, a given application or URL cannot be both prohibited (i.e., blacklisted) and allowed (i.e., whitelisted). In certain embodiments, if allowed applications are specified, the user may only work with those applications. In this embodiment, these fields are read only.

Package restrictions 1920 control which packages are prohibited. For instance, with reference to FIG. 19C, prohibited packages may be listed in prohibited packages field 1922. This may restrict categories of packages that the organization does not want a user to have access to in some embodiments. In certain embodiments, allowed packages may be listed in addition to or in lieu of prohibited packages field 1922. Prohibited packages field 1922 is read only in this embodiment.

Activity restrictions 1930 control which activities the user is and/or is not allowed to use. For instance, with reference to FIG. 19D, prohibited activities would be shown in prohibited activities field 1932 if any were prohibited and allowed activities would be shown in allowed activities field 1934 if any activities were listed as allowed. Thus, if restrictions are not desired at the level of an entire package, but there are certain activities that should not be permitted and/or only certain activities should be allowed, this can be specified via activity restrictions 1930. In this embodiment, these fields are read only.

In some embodiments, if no activities are specified as being allowed and/or disallowed, this defaults to all activities being allowed. In certain embodiments, only allowed or disallowed is enforced, but not both. For instance, in such embodiments, if both allowed and disallowed activities are included, the “allowed” set may take precedence and the disallowed set may be ignored since specifically specifying allowed activities is considered more restrictive.

Activity property requirements 1940 allow an organization to define custom rules. Returning to FIG. 19A, a rule configuration field 1942 has a value of “Property:*Draft*,Activity:*MailX,Value:True”. In this example, for MailX activities that work with Outlook® in UiPath StudioX™, they have to have the Draft properties set to True. As with the other restriction types, rule configuration field 1942 is read only for the user. As can be seen in FIGS. 19A-D, some rules are set to provide errors as a default action and others are set to provide warnings.

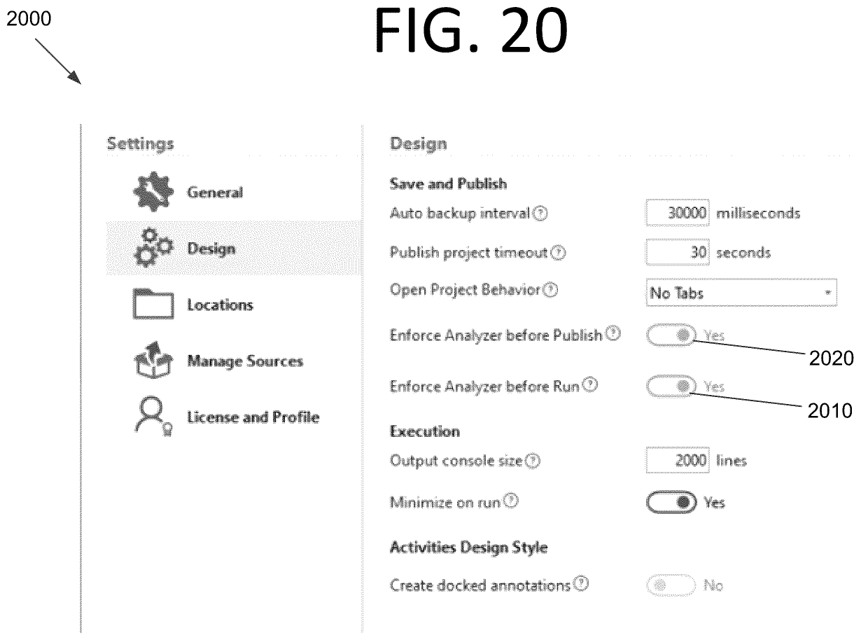

As shown in the screenshot of FIG. 20, in automation designer application settings interface 2000, various settings can be enforced for the automation workflow design. In this case, the workflow has to pass the workflow analyzer both before run and before publish. This enforcement can be seen in settings 2010 and 2020, respectively. This means that for the governance policies set as rules in workflow analyzer settings interface 1900, the workflow must comply with all rules that are set to throw an error in the case of noncompliance.

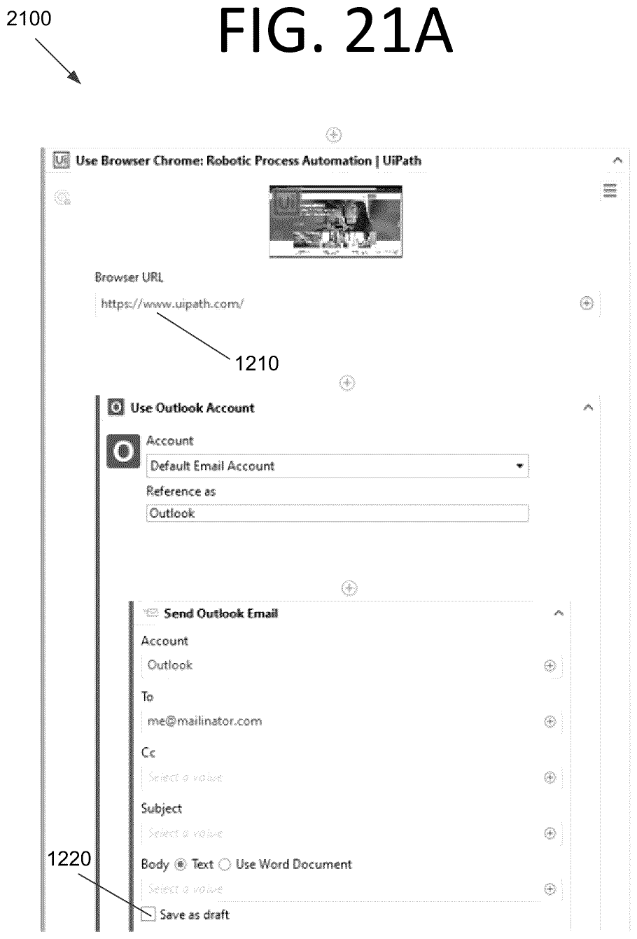

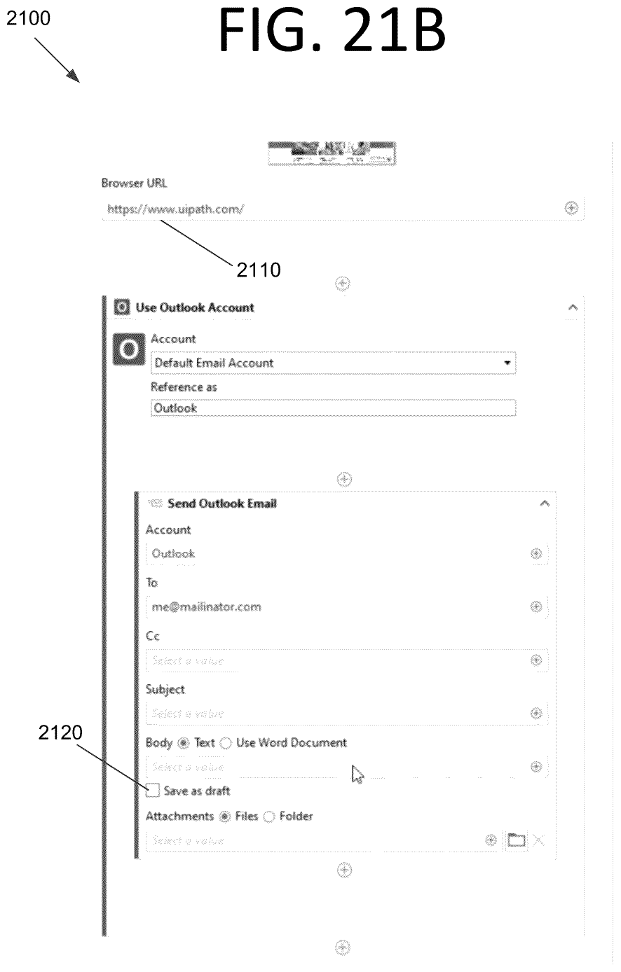

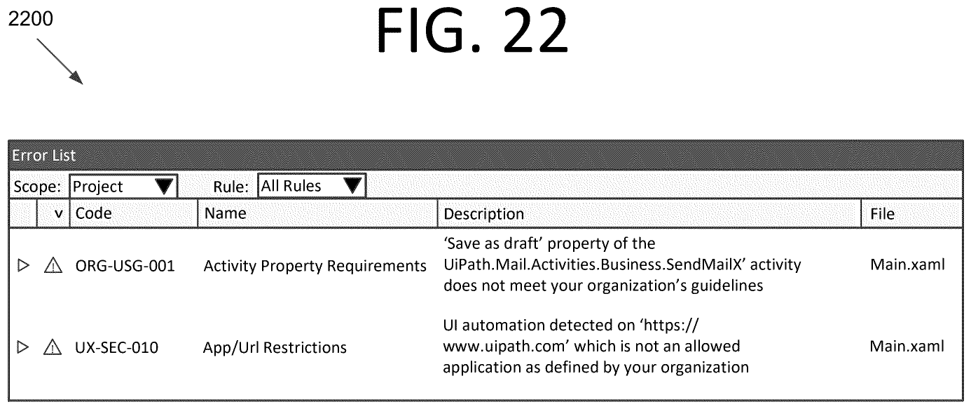

FIGS. 21A and 21B are screenshots illustrating an RPA workflow 2100, according to an embodiment of the present invention. The user is trying to automate the content at link 2110 (here, “https://www.uipath.com/”). Consider the case that this is not a permitted URL based on the rules of the workflow analyzer. Also consider the case that a rule exists requiring “save as draft” checkbox 2120 to be selected. When the user seeks to validate the workflow, an error list interface 2200 appears in this embodiment. See FIG. 22. Error list interface 2200 indicates that the “save as draft” property does not meet the organization's guidelines and that https://www.uipath.com/is not an allowed application defined by the organization for UI automation.

Per the above, policies may be defined based on the technical sophistication of the user in some embodiments. For example, more complex rules may be defined for UiPath Studio™, which tends to be used by automation developers with programming knowledge, than UiPath StudioX™, which may be used by individuals of any level of programming knowledge or even the lack thereof. For instance, users of an automation designer application that are more technically sophisticated may have access to more package feeds, have the ability to disable feeds, have a richer set of rules, etc.

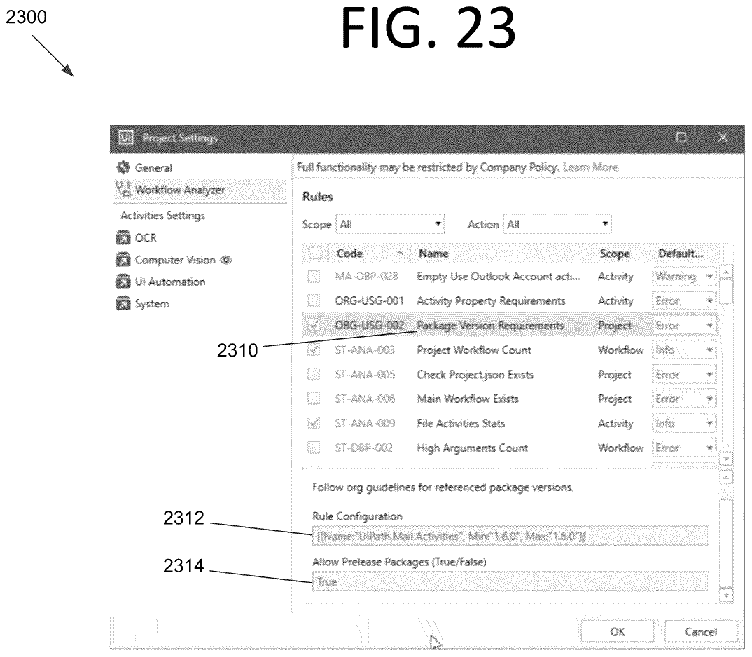

Consider workflow analyzer interface 2300 of FIG. 23. In this case, a rich set of rules is provided for an automation developer, including custom rules. A custom package version requirements rule 2310 is implemented. The mail activities “UiPath.Mail.Activities” must have a minimum version of 1.6.0 and a maximum version of 1.6.0 in rule configuration field 2312, and an error will be thrown if another version is referenced. This requires that UiPath. Mail. Activities must have exactly this version. Also, allow prerelease packages field 2314 is set to “True.”

Per the above, in some embodiments, governance is enabled as part of an installation script for an automation designer application. In certain embodiments, a remote policy file may be set via a registration key so that the automation designer application always has the current version of the governance policies. Alternatively, the policy file may be in a protected location on the local computing system on which the automation designer application resides. In some embodiments, custom rules are deployed to a protected “rules” folder as part of the installation script.

In some embodiments, separate policies are enforced for technically savvy users and users without substantial programming knowledge. In certain embodiments, different policies are applied based on a given user, the user's role, the user's group, etc. In some embodiments, users cannot run or publish noncompliant automation workflows.

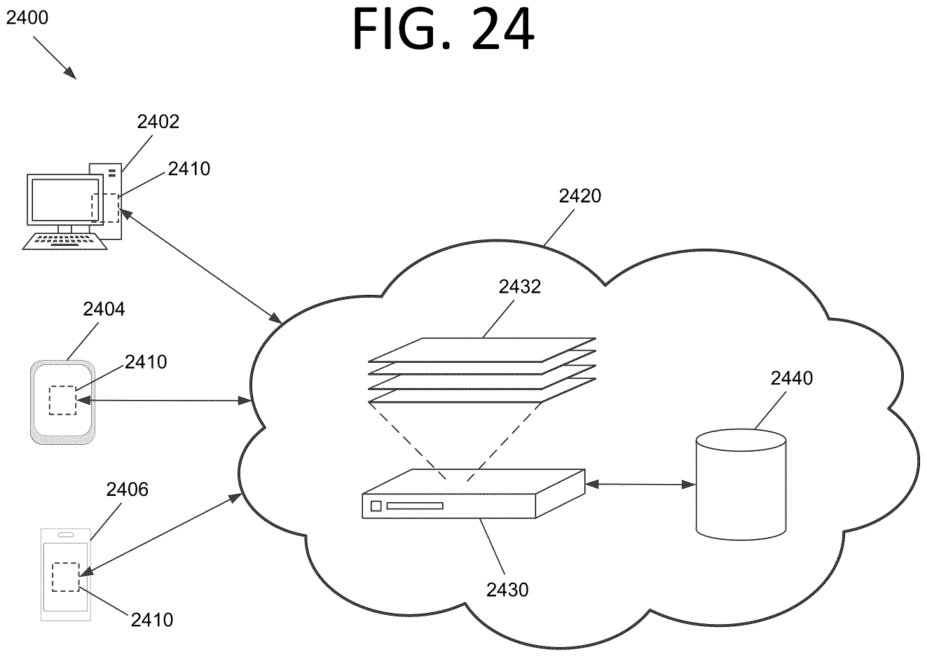

FIG. 24 is an architectural diagram illustrating a system 2400 for performing access control and governance for automations at execution, according to an embodiment of the present invention. System 2400 includes user computing systems, such as desktop computer 2402, tablet 2404, and smart phone 2406. However, any desired computing system may be used without deviating from the scope of invention including, but not limited to, smart watches, laptop computers, Internet-of-Things (IoT) devices, vehicle computing systems, etc.

Each computing system 2402, 2404, 2406 has an automation 1510 (e.g., an RPA robot or an AI agent) running thereon. However, in certain embodiments, computing systems 2402, 2404, 2406 may execute different robots. When executing its process, the automation requests certain information from a server 2430 (e.g. sending requests to a conductor application running on server 2430) via a network 2420 (e.g., a LAN, a mobile communications network, a satellite communications network, the Internet, any combination thereof, etc.). For instance, automation 2410 may communicate with server 2430 to send or receive data (e.g., pushing/pulling from a data queue), retrieve securely stored credential/asset information (e.g., usernames/passwords, access tokens, etc.), log information from the activities (e.g., execution logs), report “heartbeat status” (e.g., that automation 2410 is running correctly), check for “orchestration commands” (e.g., “run this”, “abort/cancel execution”, etc.), or any other suitable communications without deviating from the scope of the invention. In some embodiments, server 2430 may run the conductor application and the data may be sent periodically as part of the heartbeat message. Server 2430 obtains access control and governance rules for a given automation from one or more files 2432, from a database 2440, or both.

Server 2430 checks the action(s) to be performed by automation 2410 and/or the information requested by the automation against the access control and governance rules. If automation 2410 is permitted to take the action or obtain the information, server 2430 provides the requested information to automation 2410 and/or sends information to a validation application on the respective computing system indicating that the action is acceptable. If not, server 2430 does not provide the requested information to automation 2410 and/or sends information to the validation application on the respective computing system indicating that the action attempted by automation 2410 is not acceptable. In certain embodiments, the validation application may end the process associated with automation 2410.

In some embodiments, the action that is not permitted may be an action permitted for a human user but not an automation. In certain embodiments, server 2430 may verify that automation 2410 pauses long enough for one or more legacy systems and may delay obtaining the information requested by the automation or accepting new information requests from the automation until the delay period expires. In certain embodiments, governance is enforced at runtime in addition to design time enforcement. Policies may be automatically sent to computing systems 2402, 2404, 2406 in some embodiments when computing systems 2402, 2404, 2406 connect to a server-side conductor application of server 2430, for example. The automation designer application may automatically insert code into the automations that forces them to obtain these policies and operate in compliance therewith in some embodiments.

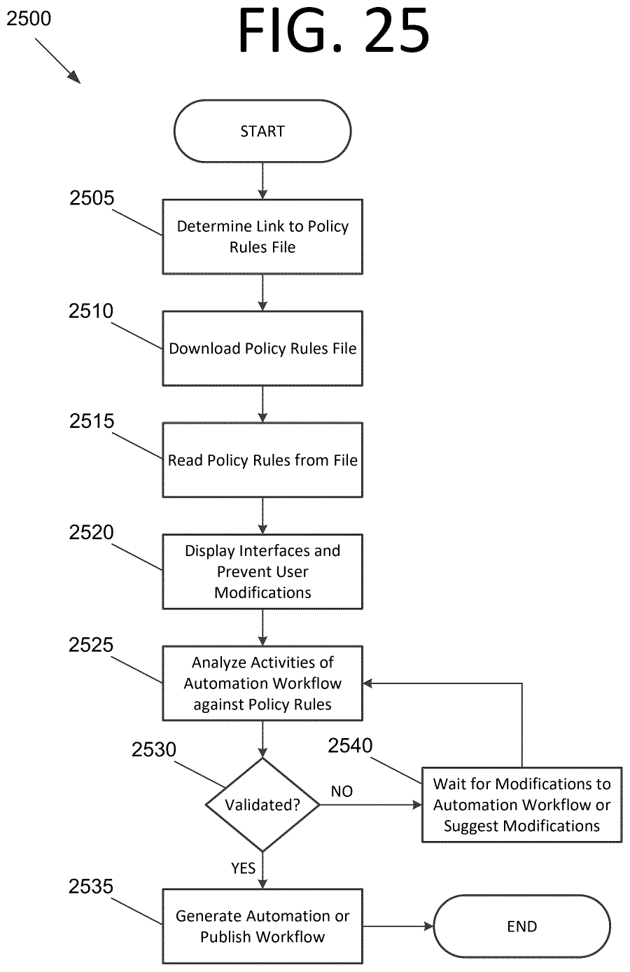

FIG. 25 is a flowchart illustrating a process 2500 for performing robot access control and governance for an automation designer application, according to an embodiment of the present invention. The process begins with determining a link to a file including access control and governance policy rules from a registry entry of a computing system at 2505 and downloading the file using the determined link at 2510. In some embodiments, the access control and governance policy rules are implemented via an installation script for the automation designer application. A workflow analyzer reads the access control and governance policy rules for the automation designer application from the file at 2515.

In some embodiments, the access control and governance policy rules include controls on which applications and/or URLs may and/or may not be automated, controls on what activities may and/or may not be used in the RPA workflow or agentic workflow, controls on what packages/tools may and/or may not be used for the workflow, or a combination thereof. In certain embodiments, the access control and governance policy rules are defined for the automation designer application based on an organization, a role, a group, an individual developer, or a combination thereof. In some embodiments, the access control and governance policy rules cannot be modified by a user of the automation designer application as enforced by an operating system of a computing system on which the automation designer application is executed. In certain embodiments, the access control and governance policy rules include one or more application and/or URL restrictions, one or more package restrictions, one or more activity restrictions, one or more activity property requirements, or a combination thereof.

In some embodiments, various interfaces may be displayed and unpermitted user modifications may be prevented at 2520. For instance, a package management interface including packages that may be accessed by the activities of a workflow may be displayed and a user of the automation designer application may be prevented from modifying the permitted packages or adding new packages that are not permitted based on the access control and governance policy rules. As another example, a workflow analyzer settings interface may be displayed that lists the access control and governance policy rules and the user of the automation designer application may be prevented from modifying the access control and governance policy rules.

Activities of the workflow of the automation designer application are analyzed against the access control and governance policy rules at 2525. In some embodiments, the analysis of the activities of the workflow includes verifying whether one or more libraries and/or tools to be accessed in a workflow activity and/or by an AI agent are included in a whitelist or not included in a blacklist. If the validation succeeds at 2530 (i.e., the workflow activities and/or automation prompts comply with all required access control and governance policy rules), an automation implementing the workflow is generated or the workflow is published at 2535. However, if the validation fails at 2530 (i.e., one or more analyzed activities of the workflow violate the access control and governance policy rules), generation of an automation or publication of the workflow is prevented until the workflow satisfies the access control and governance policy rules. In this embodiment, the workflow analyzer/designer application wait for the user to make modifications to the workflow at 2540. The process then returns to step 2525 to analyze the modified activities of the workflow. In some embodiments, only the activities that have been modified are analyzed again.

In certain embodiments, as discussed above, an AI model assists with determining whether a given automation violates access control and governance rules. In such embodiments, rather than waiting for a user to modify a workflow, the AI model suggests compliant modifications and/or makes them automatically at 2540. This may speed development and/or prevent noncompliance issues that the user may have unintentionally introduced.

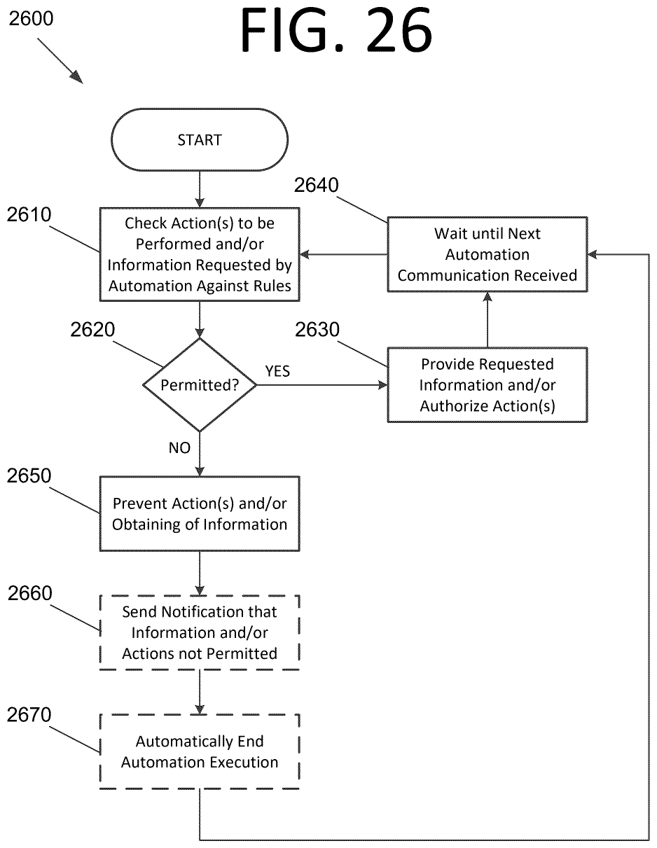

FIG. 26 is a flowchart illustrating a process 2600 for performing access control and governance for executing automations, according to an embodiment of the present invention. The process begins with checking action(s) to be performed by an automation and/or information requested by the automation against access control and governance rules at 2610. The check may be performed by a client-side or a server-side validation application, for example. If the automation is permitted to take the action(s) and/or obtain the information at 2620, the requested information is provided to the automation and/or the action(s) are authorized at 2630. The validation application then waits until a next automation communication is received at 2640.

If the automation is not permitted to take the action(s) and/or obtain the information at 2620, the validation application prevents the automation from obtaining the information and/or taking the action(s) at 2650. In some embodiments, a notification may be sent to the automation that access to the information and/or the action(s) are not permitted at 2660. In certain embodiments, the validation application may automatically end execution of the automation (e.g., by terminating a process associated with the automation) at 2670.

In some embodiments, the action that is not permitted may be an action permitted for a human user but not an automation. In certain embodiments, the validation application may verify that the automation pauses long enough for one or more legacy systems and may delay obtaining the information requested by the automation or accepting new information requests from the automation until the delay period expires.

The process steps performed in FIGS. 14, 25, and 16 may be performed by a computer program, encoding instructions for the processor(s) to perform at least part of the process(es) described in FIGS. 14, 25, and 26, in accordance with embodiments of the present invention. The computer program may be embodied on a non-transitory computer-readable medium. The computer-readable medium may be, but is not limited to, a hard disk drive, a flash device, RAM, a tape, and/or any other such medium or combination of media used to store data. The computer program may include encoded instructions for controlling processor(s) of a computing system (e.g., processor(s) 1110 of computing system 1100 of FIG. 11) to implement all or part of the process steps described in FIGS. 14, 25, and 26, which may also be stored on the computer-readable medium.

The computer program can be implemented in hardware, software, or a hybrid implementation. The computer program can be composed of modules that are in operative communication with one another, and which are designed to pass information or instructions to display. The computer program can be configured to operate on a general purpose computer, an ASIC, or any other suitable device.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A computer-implemented method for performing runtime access control and governance for automations, comprising:
checking at least one of one or more actions to be performed by an automation, information requested by the automation, one or more tools used by the automation, and one or more prompts for the automation against access control and governance rules;
responsive to the automation, based on the access control and governance rules, being permitted to perform the one or more actions, receive the requested information, use the one or more tools, and/or use the one or more prompts:
authorizing the one or more actions, providing the automation with the requested information, authorizing use of the one or more tools, and/or authorizing use of the one or more prompts; and
responsive to the automation, based on the access control and governance rules, not being permitted to perform the one or more actions, receive the requested information, use the one or more tools, and/or use the one or more prompts:
preventing the automation from taking the one or more actions, obtaining the requested information, using the one or more tools, and/or using the one or more prompts.

2. The computer-implemented method of claim 1, wherein responsive to the automation not being permitted to perform the one or more actions, receive the requested information, use the one or more tools, and/or use the one or more prompts, the method further comprises:
sending a notification to the automation or a client-side application indicating that the one or more actions, the access to the information, the use of the one or more tools, and/or the use of the one or more prompts is not permitted.

3. The computer-implemented method of claim 1, wherein responsive to the automation not being permitted to perform the one or more actions, receive the requested information, use the one or more tools, and/or use the one or more prompts, the method further comprises:
automatically ending execution of the automation.

4. The computer-implemented method of claim 1, further comprising:
automatically sending the access control and governance rules to a computing system associated with the automation responsive to the computing system connecting to a server-side conductor application.

5. The computer-implemented method of claim 1, wherein at least one of the one or more actions is permitted for a human user but not by the automation.

6. The computer-implemented method of claim 1, further comprising:
verifying that the automation pauses for at least a period of time for one or more legacy systems to perform one or more operations; and
responsive to the automation not pausing for at least the period of time:
delaying the obtaining of the information requested by the automation or accepting new information requests from the automation until the period of time expires.

7. The computer-implemented method of claim 1, wherein the runtime enforcement of the access control and governance rules is performed in addition to design time enforcement of the access control and governance rules.

8. The computer-implemented method of claim 1, wherein the automation comprises automatically inserted code that forces the automation to obtain the access control and governance rules and/or to operate in compliance with the access control and governance rules.

9. The computer-implemented method of claim 1, wherein the access control and governance rules comprise one or more application and/or universal resource locator (URL) restrictions, one or more package restrictions, one or more activity restrictions, one or more activity property requirements, or a combination thereof.

10. One or more computer programs for performing runtime access control and governance for automations embodied on one or more non-transitory computer-readable media, the one or more computer programs configured to cause at least one processor to:
check at least one of one or more actions to be performed by an automation, information requested by the automation, one or more tools used by the automation, and one or more prompts used by the automation against access control and governance rules; and
responsive to the automation, based on the access control and governance rules, not being permitted to perform the one or more actions, receive the requested information, use the one or more tools, and/or use the one or more prompts:
prevent the automation from taking the one or more actions, obtaining the requested information, using the one or more tools, and/or using the one or more prompts.

11. The computer program of claim 10, wherein responsive to the automation, based on the access control and governance rules, being permitted to perform the one or more actions, receive the requested information, use the one or more tools, and/or use the one or more prompts, the one or more computer programs are further configured to cause the at least one processor to:
authorize the one or more actions, provide the automation with the requested information, use the one or more tools, and/or use the one or more prompts.

12. The one or more computer programs of claim 10, wherein responsive to the automation not being permitted to perform the one or more actions, receive the requested information, use the one or more tools, and/or use the one or more prompts, the one or more computer programs are further configured to cause the at least one processor to:
send a notification to the automation or a client-side application indicating that the one or more actions, the access to the information, the use of the one or more tools, and/or the use of the one or more prompts is not permitted.

13. The one or more computer programs of claim 10, wherein responsive to the automation not being permitted to perform the one or more actions, receive the requested information, use the one or more tools, and/or use the one or more prompts, the one or more computer programs are further configured to cause the at least one processor to:
automatically end execution of the automation.

14. The one or more computer programs of claim 10, wherein the one or more computer programs are further configured to cause the at least one processor to:
automatically send the access control and governance rules to a computing system associated with the automation responsive to the computing system connecting to a server-side conductor application.

15. The one or more computer programs of claim 10, wherein the one or more computer programs are further configured to cause the at least one processor to:
verify that the automation pauses for at least a period of time for one or more legacy systems to perform one or more operations; and
responsive to the automation not pausing for at least the period of time:
delay the obtaining of the information requested by the automation or accepting of new information requests from the automation until the period of time expires.

16. The one or more computer programs of claim 10, wherein the automation comprises automatically inserted code that forces the automation to obtain the access control and governance rules and/or to operate in compliance with the access control and governance rules.

17. One or more computing systems, comprising:
memory storing computer program instructions; and
at least one processor configured to execute the computer program instructions, wherein the computer program instructions are configured to cause the at least one processor to:
check at least one of one or more actions to be performed by an automation, information requested by the automation, one or more tools used by the automation, and one or more prompts used by the automation against access control and governance rules, and
responsive to the automation, based on the access control and governance rules, not being permitted to perform the one or more actions, receive the requested information, use the one or more tools, and/or use the one or more prompts:
prevent the automation robot from taking the one or more actions, obtaining the requested information, using the one or more tools, and/or using the one or more prompts, and
send a notification to the automation or a client-side application indicating that the one or more actions, the access to the information, the use of the one or more tools, and/or the use of the one or more prompts is not permitted, automatically end execution of the automation, or both.

18. The one or more computing systems of claim 17, wherein responsive to the automation, based on the access control and governance rules, being permitted to perform the one or more actions, receive the requested information, use the one or more tools, and/or use the one or more prompts, the computer program instructions are further configured to cause the at least one processor to:
authorize the one or more actions, provide the automation with the requested information, authorize the automation to use the one or more tools, and/or authorize the automation to use the one or more prompts.

19. The one or more computing systems of claim 17, wherein the computer program instructions are further configured to cause the at least one processor to:
automatically send the access control and governance rules to a computing system associated with the automation responsive to the computing system connecting to a server-side conductor application.

20. The one or more computing systems of claim 17, wherein the computer program instructions are further configured to cause the at least one processor to:
verify that the automation pauses for at least a period of time for one or more legacy systems to perform one or more operations; and
responsive to the automation not pausing for at least the period of time:
delay the obtaining of the information requested by the automation or accepting of new information requests from the automation until the period of time expires.
